(19) United States
(12) Patent Application Publication
(10) Pub. No.: US 2018/0200834 A1
(43) Pub. Date: Jul. 19, 2018

(54) METHODS OF PREPARING ALLOYS HAVING TAILORED CRYSTALLINE STRUCTURES, AND PRODUCTS RELATING TO THE SAME

(71) Applicant: ARCONIC INC., Pittsburgh, PA (US)

(72) Inventors: Raymond J. Kilmer, Pittsburgh, PA (US); Zhi Tang, Pittsburgh, PA (US); Lynette M. Karabin, Ruffs Dale, PA (US); David W. Heard, Pittsburgh, PA (US)

(21) Appl. No.: 15/872,732

(22) Filed: Jan. 16, 2018

Related U.S. Application Data
(60) Provisional application No. 62/446,598, filed on Jan. 16, 2017.
(60) Provisional application No. 62/451,408, filed on Jan. 27, 2017.
(60) Provisional application No. 62/558,221, filed on Sep. 13, 2017.

(51) Int. Cl. B23K 26/34; B33Y 10/00; B33Y 70/00; C22C 30/00; B23K 26/354

(52) U.S. Cl. CPC B23K 26/34; B33Y 10/00; B23K 26/354; C22C 30/00; B33Y 70/00

(57) ABSTRACT

The present disclosure relates to methods of additively manufacturing multi-region alloy products. The multi-region products generally comprise a first region having a first crystallographic structure, and a second region having a second crystallographic structure, different than the first, wherein at least one of the first and the second crystallographic structures is a multi-phase microstructure. In one embodiment, an energy source is used to selectively produce at least some of the first region and/or at least some of the second region. The locations and/or volumes of one or more regions may be preselected and/or controlled so as to produce multi-region products having tailored microstructures.

### CROSS-REFERENCE TO RELATED APPLICATIONS

This application claims the benefit of priority of U.S. Provisional Patent Application No. 62/446,598, filed Jan. 16, 2017; and claims the benefit of priority of U.S. Provisional Patent Application No. 62/451,408, filed Jan. 27, 2017; and claims the benefit of priority of U.S. Provisional Patent Application No. 62/558,221, filed Sep. 13, 2017, entitled “METHODS OF PREPARING ALLOYS HAVING TAILORED CRYSTALLINE STRUCTURES, AND PRODUCTS RELATING TO THE SAME”. Each of the above-identified patent applications is incorporated herein by reference in its entirety.

### FIELD OF THE INVENTION

This patent application relates to methods of preparing alloys having tailored crystalline structures, and products relating to the same.

### BACKGROUND

An alloy is a mixture of chemical elements, which forms an impure substance (admixture) that retains the characteristics of a metal. An alloy is distinct from an impure metal in that, with an alloy, the added elements are well controlled to produce desirable properties. Alloys are made by mixing two or more elements, at least one of which is a metal. This is usually called the primary metal or the base metal, and the name of this metal may also be the name of the alloy.

### SUMMARY OF THE INVENTION

Broadly, the present disclosure relates to methods of additively manufacturing multi-region alloy products. The multi-region products generally comprise a first region having a first crystallographic structure, and a second region having a second crystallographic structure, different than the first, wherein at least one of the first and the second crystallographic structures is a multi-phase microstructure (defined below). In one embodiment, an energy source is used to selectively produce at least some of the first region and/or at least some of the second region. The locations and/or volumes of one or more regions may be preselected and/or controlled so as to produce multi-region products having tailored microstructures. These one or more preselected microstructural regions may be preselected to correspond to one or more preselected desired properties of the multi-region alloy product. Accordingly, a first region may realize a first property, such as strength, ductility, fatigue, corrosion resistance, fracture toughness and/or modulus, among others, and a second region may realize a second property different than the first (e.g., a materially different strength, ductility, fatigue, corrosion resistance, fracture toughness and/or modulus, as compared to the second region). Thus, predetermined/tailored additively manufacturing multi-region alloy products may be produced.

The figures constitute a part of this specification and include illustrative embodiments of the present disclosure and illustrate various objects and features thereof. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references, unless the context clearly dictates otherwise. The meaning of “in” includes “in” and “on”, unless the context clearly dictates otherwise.

### I. Control of Solidification Rates and Thermal History

The multi-region products may be produced and/or maintained by controlling the production conditions and/or environmental conditions in which the products are produced. For instance, the solidification rate(s) associated with production of one or more portions of the product may be controlled to facilitate production of one or more preselected microstructures (e.g., a multi-phase microstructure, a dual-phase microstructure, a single-phase microstructure).

Solidification rate(s) may be at least partially controlled, for instance, by utilizing the appropriate energy source (e.g., a laser, an electron beam, a plasma beam, and equivalents thereof) and/or appropriate rastering pattern of either continuous or pulsed (defined below) energy source during the additive manufacturing process, thereby achieving a preselected melt pool and associated solidification rate(s). The parameters for the energy source may be preselected, for instance, power, size (e.g., beam size), wavelength, hatch spacing, and/or duration of the energy source. See, e.g., “Influence of hatch spacing on heat and mass transfer, thermodynamics and laser processability during additive manufacturing of Inconel 718 alloy,” by Xia et al., International Journal of Machine Tools and Manufacture, Vol. 109, October 2016, Pages 147-157 (http://www.sciencedirect.com/science/article/pii/S0890695516300906). In one embodiment, the rastering of a continuous energy source may utilize a first hatch spacing in a first region having the first microstructure, and a second hatch spacing in a second region having the second microstructure. Alternatively, the rastering of a continuous energy source may utilize a first velocity in a first region having the first microstructure, and a second velocity in a second region having the second microstructure. Similarly, the energy source may be pulsed, and the pulse may vary, as appropriate, to achieve the preselected solidification rate(s). For instance, a short pulse duration (e.g., nanoseconds) may be used when making a small melt pool. A longer pulse duration (e.g., seconds) or a scan may be used, such as when creating a large melt pool. For purposes of this patent application, a continuous wave is equivalent to a long pulse.

Solidification rate(s) of one or more melt pools may also be controlled by controlling the materials located proximal the melt pool. For instance, an appropriate volume of material (which may the metal feedstock itself, or another material) may be used to achieve the appropriate thermal conductivity proximal the melt pool(s), thereby achieving the corresponding appropriate solidification rate(s). In another approach, the platen of an additive manufacturing apparatus is used to at least partial facilitate the appropriate solidification rate(s), as described in further detail below. In another approach, one or more walls proximal a platen or a build substrate may be used to at least partially facilitate the appropriate solidification rate(s).

The solidification rate(s) of one or more melt pools may also be controlled by controlling appropriate other conditions, such the environmental conditions surrounding the melt pools (e.g., the surrounding temperature(s) and/or pressure(s). In one embodiment, and as described in further detail below, an additive manufacturing apparatus may include a controlled atmosphere to control at least one of temperature exposure and/or pressure exposure during the build cycle, which may at least partially facilitate achievement of the appropriate solidification rate(s).

In one embodiment, a predetermined threshold solidification rate is determined for a particular material (e.g., a particular alloy, a set of alloys, a class of alloys), at or above which a first region will generally form from the molten pool, and below which a second region will generally form from the molten pool. Therefore, during the additively manufacturing, tailored first regions may be produced by maintaining the solidification rate of the appropriate molten pool(s) at or above the predetermined threshold solidification rate. Instrumentation associated with the solidification rate (e.g., the energy beam, the platen, the additive manufacturing apparatus environment) may thus be controlled and/or pre-programmed to facilitate production of the first regions. Likewise, during the additively manufacturing, tailored second regions may be produced by maintaining the solidification rate of the appropriate molten pool(s) below the predetermine threshold solidification rate. Again, instrumentation associated with the solidification rate (e.g., the energy beam, the platen, the additive manufacturing apparatus environment) may thus be controlled and/or pre-programmed to facilitate production of the second regions. In one embodiment, bcc forms at or above the predetermined threshold solidification rate, and another or mixed crystalline phase (e.g., fcc+bcc) forms below the predetermined threshold solidification rate. In one embodiment, maintaining the solidification rate at or above the predetermined threshold solidification rate results in a first region consisting of a single phase microstructure (e.g., consisting essentially of bcc). In one embodiment, maintaining the solidification rate below the predetermined threshold solidification rate results in a second region having a multi-phase microstructure (e.g., consisting essentially of bcc+fcc). The terms “single phase microstructure” and “multi-phase microstructure” are defined later in this patent application.

An additive manufacturing apparatus may comprise a solid platen, on which the multi-region alloy body may be produced. The temperature of one or more portions of this platen may be controlled (e.g. via a temperature control system associated with the additive manufacturing apparatus) to facilitate realization of one or more appropriate exposure temperatures. These exposure temperatures may be utilized to facilitate production of and/or maintenance of the microstructures of one or more regions of the multi-region alloy product, such as by facilitating the appropriate solidification rate(s) and/or facilitating appropriate post-solidification thermal exposures for the first and/or second regions.

As one example, a platen may comprise a first portion and a second portion, where the first portion may be heated to a first temperature, and a second portion may be heated to a second temperature, different than the first (e.g., via one or more appropriate heating mechanisms and controllers associated with the platen and the additive manufacturing apparatus). These different portions and temperatures of the platen may be utilized to induce and/or maintain corresponding temperatures of the first and second regions of the multi-phase product. Appropriate heating mechanisms (e.g., resistance wires, induction, radiation) may be used in the platen and one or more corresponding temperature controllers may be used to facilitate the appropriate platen temperature profile. Third, fourth, or more additional platen portions may be used in the platen to realize corresponding third, fourth or more other temperatures, different than the first and second temperatures. In another embodiment, the platen comprises a generally uniform temperature.

The platen may also use multiple materials to realize the appropriate platen temperature profile. For instance, a first portion of the platen may comprise a first material having a first thermal conductivity, and a second portion of the platen may comprise a second material having a second thermal conductivity, different than the first. During operation, the first platen material may realize a first temperature and the second platen material may realize a second temperature, different than the first. These different portions and temperatures of the platen may be utilized to induce and/or maintain corresponding temperatures of the first and second regions of the multi-phase product. In one embodiment, a generally equal current and/or voltage is supplied to these first and second materials, but, due to differences in their thermal conductivity, these first and second materials realize different temperatures. Third, fourth, or more additional materials may be used in the platen to realize corresponding third, fourth or more other temperatures, different than the first and second temperatures.

Aside from a platen, one or more walls may be associated with the platen (e.g., disposed on or proximal the platen) or a build substrate. Like the platen, these one or more walls may be used to facilitate the appropriate solidification rate(s) and/or control the thermal history of the multi-region alloy product, and these surrounding walls may include a plurality of different regions adapted to realize one or more controlled temperatures (e.g., via appropriate electrical connection to one or more temperature controllers associated with the additive manufacturing apparatus). These surrounding walls may selectively heat, cool, and/or maintain the temperature of one or more portions of the multi-region alloy product during the build cycle (e.g., via radiation, conduction and/or convection).

Aside from solids, appropriate fluids may be used to facilitate the appropriate solidification rate(s) and/or control the thermal history and/or pressure history of the multi-region alloy product. For instance, the additive manufacturing apparatus may comprise a controlled atmosphere (e.g., is sealed-off from the outside environment) where the multi-region alloy product is produced during the build cycle. One or more appropriate gases (e.g., an inert gas) may be used within the controlled atmosphere to facilitate realization of the appropriate solidification rate(s) and/or temperature exposure history and/or pressure exposure history of the alloy body. In this regard, one or more nozzles, jets, or other fluid spraying apparatus may be used to selectively heat, cool or maintain the temperature of the appropriate region(s) of the alloy product during the build cycle, such by selectively spraying one or more fluids toward one or more locations of the alloy body (e.g., toward one or more preselected locations). Similar principles apply to the use of liquids.

Pressure may also be controlled to facilitate realization of/maintenance of the appropriate regions of the multi-region alloy product. For instance, the additive manufacturing apparatus may comprise a controlled atmosphere (e.g., is sealed-off from the outside environment) where the multi-region alloy product is produced during the build cycle. The pressure of the controlled atmosphere may be controlled during the build cycle to facilitate realization of the appropriate pressure(s). In one embodiment, a vacuum is used during one or more portions of the build cycle to facilitate realization of and/or maintenance of the appropriate regions of the multi-region alloy product. In one embodiment, radiative heating is used while the controlled atmosphere is under vacuum so as to heat, cool and/or maintain the temperature of one or more portions of the alloy body during one or more build cycles.

### II. The Multi-Region Body

As one non-limiting example, and referring now to FIG. 1, an additively manufactured alloy body (1) includes a first region (10) and a plurality of second regions (20). The alloy body (1) includes a plurality of layers (1 to n), each layer being produced as part of a build cycle of an additive manufacturing process. A build substrate (not illustrated) may be attached to the product, and this build substrate may be removed upon completion of the additive manufacturing process, or may be included in the final additively manufactured product. The build substrate may be any suitable material (e.g., metallic, an alloy, a metal-matrix composite, a ceramic). While the regions of FIG. 1 are generally being shown as being rectangular, this is for illustrative purposes only as the regions in reality are generally irregular.

a. Microstructures

The first region (10) of the alloy product (1) may have a first crystallographic structure and the second regions (20) may have a second crystallographic structure, different than the first, where at least one of the first and second crystallographic structures is a multi-phase microstructure. The different crystallographic structures of the first and second regions (10, 20) are generally due to at least one of a compositional and/or lattice parameter difference. For instance, and as one non-limiting example, the first region (10) may be a multi-phase microstructure, generally comprising at least two of: an fcc microstructure (whether random or ordered), a bcc microstructure (whether ordered or random), an HCP microstructure (whether ordered or random; includes DHCP, double hexagonal close packed), an orthorhombic microstructure (whether random or ordered), and a tetragonal microstructure (whether random or ordered). The second regions (20) may be a single phase microstructure generally consisting essentially of an fcc microstructure, a bcc microstructure, an HCP microstructure, an orthorhombic microstructure, and a tetragonal microstructure, all of which may be either random or ordered. Alternatively, the second regions (20) may be a multi-phase microstructure, generally different than that of the first region (10). As one example, the first region (10) may have a first multi-phase microstructure and the second regions may have a second multi-phase microstructure, different than the first. As another example, the second regions (20) may be a multi-phase microstructure and the first region (10) may be a single-phase microstructure.

As used herein, a “single-phase microstructure” means a matrix of an alloy body having a crystalline structure that generally includes 95 vol. % or more of only one of an fcc, a bcc, an HCP, an orthorhombic, or a tetragonal crystalline structure. In one embodiment, a single-phase microstructure comprises at least 97% of an fcc, a bcc, an HCP, an orthorhombic, or a tetragonal crystalline structure. In another embodiment, a single-phase microstructure comprises at least 98% of an fcc, a bcc, an HCP, an orthorhombic, or a tetragonal crystalline structure. In another embodiment, a single-phase microstructure comprises at least 99% of an fcc, a bcc, an HCP, an orthorhombic, or a tetragonal crystalline structure. An fcc microstructure may be random or ordered (e.g., L1₂). A bcc microstructure may be random or ordered (e.g., B2). The HCP phase may be random or ordered (e.g., DO₁₉). An HCP microstructure may be simple HCP or an DHCP structure. An orthorhombic microstructure may be random or ordered. A tetragonal microstructure may be random or ordered. Precipitates or dispersoids, for instance, may be included in a single-phase microstructure.

As used herein, “multi-phase microstructure” means a matrix of an alloy body having a crystalline structure that generally includes at least 3 vol. % of at least two of: an fcc, a bcc, an HCP, an orthorhombic, and a tetragonal crystalline structure. For instance, a multi-phase microstructure may be an fcc+bcc microstructure, where the fcc phase and bcc phase are generally distributed throughout the first region, wherein the volume fraction of both the fcc and bcc phases are at least 3%. Similar principles apply to other multi-phase microstructures. Any of the fcc, bcc, HCP, orthorhombic or tetragonal crystalline structures (if present in the multi-phase microstructure) may be random or ordered. In one embodiment, a multi-phase microstructure comprises at least 5 vol. % of the at least two crystalline phases (e.g., at least 5 vol. % of each of fcc and bcc). In another embodiment, a multi-phase microstructure comprises at least 10 vol. % of the at least two crystalline phases (e.g., at least 10 vol. % of each of fcc and bcc). In yet another embodiment, a multi-phase microstructure comprises at least 20 vol. % of the at least two crystalline phases (e.g., at least 20 vol. % of each of fcc and bcc). Precipitates or dispersoids, for instance, may be included in a multi-phase microstructure.

In one embodiment, the first region is a dual-phase microstructure and the second regions are single-phase microstructures. In one embodiment, the first region comprises fcc(1)+bcc(1), and the second regions consist essentially of fcc(2) or bcc(2), where fcc(1) is the fcc crystalline structure of the first region, bcc(1) is the bcc crystalline structure of the first region, fcc(2) is the fcc crystalline structure of the second region (if present), and bcc(2) is the bcc crystalline structure of the second region (if present). The lattice parameter of fcc(1) is generally different than the lattice parameter of fcc(2). The lattice parameter of bcc(1) is generally different than the lattice parameter of bcc(2) of the second region. Similar principles apply to fcc+HCP, bcc+HCP and other potential dual-phase microstructures and corresponding single-phase regions.

b. Example of Second Region Production

In one embodiment, one or more second regions may be produced, for instance, via selective heating of a portion of the first region, such as by the method illustrated in FIGS. 2a-2c. In FIG. 2a, a metal feedstock (40) is provided to an additive manufacturing apparatus, and an energy source (50) is used to create melt pool (60) from this feedstock (40). A portion of the underlying substrate (35) (e.g., the build plate), may be partially melted, if appropriate. The pulse (e.g., power, size, wavelength, amplitude, and/or duration) of the energy source (50) may be controlled to facilitate production of a multi-phase alloy region (70), as shown in FIG. 2b. For instance, the pulse may be controlled to achieve the appropriate melt pool size and/or solidification rate associated with the melt pool. Next, and referring now to FIG. 2c, an energy source, which may be the same as or different than that used to produce the multi-phase region (70), may melt a portion (e.g., a preselected portion) of this multi-phase alloy region (70) via an appropriate pulse. The pulse may be controlled to achieve the appropriate melt pool size and/or solidification rate associated with the melt pool, thereby achieving single-phase region (80). These steps may be repeated, as necessary/appropriate, building tailored layers having preselected volumes of multi-phase and/or single-phase microstructures within the final additively manufactured body (e.g., as illustrated in FIG. 1).

In one embodiment, one or more first regions are produced by selectively directing an energy source at a metal feedstock. In one embodiment, one or more second regions are produced by selectively directing an energy source at the same metal feedstock, but using a different pulse. In one embodiment, one or more second regions are produced by selectively directing an energy source at a different metal feedstock (compositionally different), but using the same pulse as used to produce the one or more first regions. In one embodiment, one or more second regions are produced by selectively melting a portion of a first region using an appropriate pulse of an energy source.

In one embodiment, a method includes using a first pulse is used to create the first region, and a second pulse is used to create the second region. In one embodiment, the same energy source is used to create both the first and second regions. In another embodiment, a first energy source is used to create the first region, and a different energy source is used to create the second region. Thus, an additive manufacturing apparatus may comprise a plurality of energy sources, each of which may be configured to provide a plurality of different pulses.

c. Non-Limiting, Illustrative Configurations

Referring still to FIG. 1, the second regions (20) are generally at least partially disposed within the first region (10). In one embodiment, and as illustrated, the first region (10) is a bulk region, and the second regions (20) are intermittently dispersed throughout the bulk region. The location and/or volume of the second regions (20) may be predetermined/preselected relative to one or more locations and/or volumes of the first region (10). Accordingly, the first region (10) may comprise one or more properties that are enhanced or absent from the second regions (20). Likewise, the second regions (20) may comprise one or more properties that are enhanced or absent relative to the first region. Thus, one or more properties of the additively manufactured alloy body (1) may be predetermined/preconfigured. For instance, the second regions (20) may have enhanced strength relative to the first region (10), and the first region may have enhanced ductility relative to the second regions. In one embodiment, a network/skeleton of second regions (20) are produced within the first region (10) to facilitate improved structural integrity and/or other properties.

One non-limiting example is illustrated in FIG. 3a, where a second region (20) is associated with an upper portion of the additively manufactured alloy body (1a). As an example, the process illustrated in FIGS. 2a-2c, and described above, could be used to create a surface layer having a microstructure different than that of the underlying first region (10) of the alloy body. This surface layer may be used, for instance, to increase the hardness of the upper surface of the additively manufactured alloy body (1a). Other properties of the second region (20) could also be enhanced or degraded relative to the first region (10) to facilitate appropriate property differentials in the body (1a).

As another example, and referring now to FIG. 3b, second regions (20) may be associated with one or more sides of the additively manufactured alloy body (1b). As an example, the process illustrated in FIGS. 2a-2c, and described above, could be used to create one or more side layers having a microstructure different than that of the adjacent first region (10) of the alloy body. These layers may be used, for instance, to increase the hardness of the outer surface of the additively manufactured alloy body (1b). Other properties of the second regions (20) could also be enhanced or degraded relative to the first region (10) to facilitate appropriate property differentials in the body (1b).

As another example, and referring now to FIG. 3c, a second region (20) may be associated with a bottom of the additively manufactured alloy body (1c). As an example, the process illustrated in FIGS. 2a-2c, and described above, could be used to create the bottom layer (e.g., create from the first region, create from the build substrate, or create from both the first region and the build substrate) having a microstructure different than that of the upper first region (10) of the alloy body. This bottom layer may be used, for instance, to increase the hardness of the lower surface of the additively manufactured alloy body (1c). Other properties of the second region (20) could also be enhanced or degraded relative to the first region (10) to facilitate appropriate property differentials in the body (1c).

As another example, and referring now to FIG. 3d, the entire outer surface may be second regions (20). As described above, the outer surfaces may have at least one property (e.g., a hardness) that is different the properties of the internal first region (10). Further any combination of bottom, top, and sides per FIGS. 3a-3c may be used, as appropriate, to tailor microstructures and properties of the alloy body.

As another example, and referring now to FIG. 3e, a plurality of second region (20) layers may be produced horizontally within the additively manufactured alloy body (1d). These layers may be used to facilitate appropriate alternating of properties between the first region (10) and the second regions (20). Similar principles apply to FIG. 3f, where the plurality of second regions (20) are vertical instead of horizontal.

As made apparent by the above figures, the second region(s) may be fully encapsulated within the first region, or may be only partially encapsulated by the first region when a region is located at the surface of the alloy body. Further, any suitable arrangement of the first and second region(s) may be produced to facilitate alloy bodies having predetermined and tailored properties. Further, the size and/or volumes of the second regions (20) may be preselected and at a microscopic scale. For instance, the second regions (20) may be produced by selectively directing an energy source at a metal feedstock or a portion of the first region (100), thereby creating at least a portion of a second region. To facilitate creation of the second region, the pulse may be controlled, such as by controlling the power and/or duration and/or size of the pulse (e.g., a laser pulse). In one embodiment, a second region (20) occupies a cross-sectional area that is ten times or less the average grain size of the grains of the second region, and whether the grains are equiaxed or elongated. In another embodiment, a second region (20) occupies a cross-sectional area that is eight times or less the average grain size of the grains of the second region. In another embodiment, a second region (20) occupies a cross-sectional area that is six times or less the average grain size of the grains of the second region. In another embodiment, a second region (20) occupies a cross-sectional area that is five times or less the average grain size of the grains of the second region. In another embodiment, a second region (20) occupies a cross-sectional area that is four times or less the average grain size of the grains of the second region. In another embodiment, a second region (20) occupies a cross-sectional area that is three times or less the average grain size of the grains of the second region. In one embodiment, a second region (20) occupies a cross-sectional area that is two times or more the average grain size of the grains of the second region. In one embodiment, the grains are equiaxed. In another embodiment, the grains are elongated. In one embodiment, a second region has a length of at least from 50 microns (e.g., length being along the x-axis of FIG. 3a-3f). In one embodiment, a second region has a length of from 50 to 500 microns.

While the above figures and description relates to one or more second regions (20) disposed within a first region (10), multiple first and second regions may be produced/utilized. Also, there may be a single bulk second region (20), and a plurality of the first regions (10). Further, one or more third regions, or one or more third and fourth regions, and so on, may be produced/utilized, each region having a matrix with its own distinct crystallographic microstructure, where at least one of matrix comprises a multi-phase microstructure. The locations, sizes and/or volumes of the first region, second region, third region, and so on, may be predetermined relative to one another so as to facilitate production of the tailored alloy bodies.

As shown above, at least some of the first region, the second region, or both, are produced via additive manufacturing. In one embodiment, all of the first and second regions are produced by additive manufacturing. In another embodiment, at least a portion of either a first or second region is produced in an alternate manner. For instance, a build substrate may be a non-additively manufactured metal substrate (e.g., a cast or wrought product, such as a case sheet or plate, or a wrought extrusion or forging), having a single-phase microstructure. A multi-phase feedstock (i.e., a feedstock capable of producing a multi-phase microstructure) may be supplied to the build substrate, after which the multi-phase feedstock is subjected to an energy source to produce one or more multi-phase microstructural regions atop the build-substrate. Thus, after production, the first regions comprise the build substrate having the single-phase microstructure, and the second regions comprise the multi-phase microstructure regions atop the build-substrate.

As another example, one or more intermediate versions of the alloy body may be sprayed or otherwise supplied with other materials (e.g., other metals or alloy), thereby producing one or more non-additively manufactured regions within the alloy body. Other manners of including non-additively manufactured regions within the alloy body may be used.

d. Grain Orientation/Texture

In one approach, controlled solidification rates and/or thermal exposure history are used to produce additively manufactured products having tailored grain orientation or texture. For instance, a first region (10) of the alloy product (1) may have a first texture and the second region (20) may have a second texture, different than the first. In this regard, the first and second regions need not necessarily be a multi-phase microstructure. That is, both the first and second regions may be a single phase microstructure, but may have specifically tailored different grain orientations due to controlled solidification rates and/or thermal exposure history. In one embodiment, a first solidification rate is used to produce a first region having a first preselected texture, and a second solidification rate is used produce a second region having a second preselected texture, different than the first. In one embodiment, the first and second regions have the same composition, but have different textures due to the preselected and tailored solidification rates. In one embodiment, the first and second regions have the same composition but have different textures due to the preselected and tailored thermal exposure history. In one embodiment, the first and second regions are both fcc regions but have different textures. In one embodiment, the first and second regions are both bcc regions but have different textures. Similar principles apply to HCP, orthorhombic, and tetragonal materials. Control of textures may be in addition to, or in lieu of, control of the microstructure of the first and second regions.

### III. Additive Manufacturing

The additively manufactured body (1) may be created by supplying a feedstock to an additively manufacturing apparatus. As used herein, “additive manufacturing” and the like means “a process of joining materials to make objects from 3D model data, usually layer upon layer, as opposed to subtractive manufacturing methodologies”, as defined in ASTM F2792-12a entitled “Standard Terminology for Additively Manufacturing Technologies”. The multi-region alloy products described herein may be manufactured via any appropriate additive manufacturing technique described in this ASTM standard, such as binder jetting, directed energy deposition, material extrusion, material jetting, powder bed fusion, or sheet lamination, among others. In one embodiment, an additive manufacturing process includes depositing successive layers of one or more powders and then selectively melting and/or sintering the powders to create, layer-by-layer, the alloy product having the first regions and second regions. In one embodiment, an additive manufacturing processes uses one or more of Selective Laser Sintering (SLS), Selective Laser Melting (SLM), and Electron Beam Melting (EBM), among others. In one embodiment, an additive manufacturing process uses an EOSINT M 280 Direct Metal Laser Sintering (DMLS) additive manufacturing system, or comparable system, available from EOS GmbH (Robert-Stirling-Ring 1, 82152 Krailling/Munich, Germany), such as when higher solidification rates are desired/required. In one embodiment, when slower solidifications rates are desired/required, a laser engineered net shaping (LENS) metal 3D printing process may be used (e.g., available from OPTOMEC INC., 3911 Singer Blvd. NE, Albuquerque, N. Mex. 87109 USA.)

### IV. Build Substrates, Feedstocks and Compositions

To additively build the alloy body, a feedstock is generally supplied to/used by the additive manufacturing apparatus. The feedstock may be of any suitable form, and may include powders and/or wires, among others. As mentioned above, a build substrate may be used during the build (e.g., to facilitate deposition of a feedstock and corresponding further build of the alloy body), and this build substrate be any suitable material (e.g., metallic, an alloy, a metal-matrix composite, a ceramic).

The feedstock may be of any suitable composition capable of producing the alloy bodies having the first crystalline microstructure of the first region and the second crystalline microstructure of the second region. In one approach, the feedstock comprises a sufficient amount of a metal and/or the metal alloy to produce an additively manufactured alloy product. In one embodiment, the additively manufactured alloy product is nickel-based. In another embodiment, the additively manufactured alloy product is iron-based. In yet another embodiment, the additively manufactured alloy product is titanium-based. In another, the additively manufactured alloy product is cobalt-based. In yet another embodiment, the additively manufactured alloy product is chromium-based. In another, the additively manufactured alloy product is aluminum-based. As used herein, a metal “based” product means that the product includes that metal as the predominate element. For instance, a nickel-based product includes nickel as the predominate element. The same applies to iron, titanium, cobalt, chromium or aluminum-based products.

In one approach, a multi-component alloy may be used to produce the additively manufactured alloy bodies having the first region and the second region. As another example one or more steels may be used to produce the additively manufactured alloy bodies having the first region and the second region. As another example one or more titanium alloys (titanium based) may be used to produce the additively manufactured alloy bodies having the first region and the second region (e.g., alpha-beta titanium alloys, such as Ti-6Al-4V). As another example, one or more nickel alloys (nickel based) may be used to produce the additively manufactured alloy bodies having the first region and the second region. As another example, one or more aluminum alloys (aluminum based) may be used to produce the additively manufactured alloy bodies having the first region and the second region. As another example, one or more cobalt alloys (cobalt based) may be used to produce the additively manufactured alloy bodies having the first region and the second region. As another example, one or more chromium alloys (chromium based) may be used to produce the additively manufactured alloy bodies having the first region and the second region.

As used herein, “multi-component alloy” and the like means an alloy with a metal matrix, where at least four different elements make up the matrix, and where the multi-component alloy comprises 5-35 at. % of the at least four elements. In one embodiment, at least five different elements make up the matrix, and the multi-component alloy comprises 5-35 at. % of the at least five elements. In one embodiment, at least six different elements make up the matrix, and the multi-component alloy comprises 5-35 at. % of the at least six elements. In one embodiment, at least seven different elements make up the matrix, and the multi-component alloy comprises 5-35 at. % of the at least seven elements. In one embodiment, at least eight different elements make up the matrix, and the multi-component alloy comprises 5-35 at. % of the at least eight elements.

In one approach, a multi-component alloy includes at least 2 of Al, Ni, Fe, Cr, Co, and Mn. In one embodiment, a multi-component alloy includes at least 3 of Al, Ni, Fe, Cr, Co and Mn. In yet another embodiment, a multi-component alloy includes at least 4 of Al, Ni, Fe, Cr, Co, and Mn. In another embodiment, a multi-component alloy includes Al, Ni, Fe, Cr, and Co, but is essentially free of Mn (i.e., Mn is present only as an impurity). In yet another embodiment, a multi-component alloy is an AlₓCoCrFeNi alloy. As one example, the AlₓCoCrFeNi alloys described in “Additive Manufacturing of High-Entropy Alloys by Laser Processing,” by Ocelik, V. et al., JOM, Vol. 68, No. 7, Apr. 4, 2016, may be used, and the portion of this article relating to these compositions is incorporated herein by reference.

In one approach, the multi-component alloy is an alloy described in commonly-owned U.S. Non-Provisional patent application Ser. No. 15/727,369, or the related U.S. Provisional patent applications (U.S. Provisional Patent Application Nos. 62/402,409 and 62/523,101). Thus, the alloy compositions described in U.S. Non-Provisional patent application Ser. No. 15/727,369 and related Provisional Patent Applications Nos. 62/402,409 and 62/523,101 are incorporated herein by reference. In this regard, a multi-component alloy may include, and therefore the additively manufactured alloy product may include, 20-40 at. % Ni, 15-40 at. % Fe, 5-20 at. % Al, and 5-26 at. % Cr, wherein the alloy includes a sufficient amount of the Ni, Fe, Al, and Cr to realize the mixed fcc+bcc crystalline structure. Furthermore, optional incidental elements may include up to 15 at. %, in total, of one or more of cobalt (Co), copper (Cu), molybdenum (Mo), manganese (Mn), and tungsten (W), up to 10 at. %, in total, of one or more of niobium (Nb), tantalum (Ta), and titanium (Ti), up to 10 at. % carbon (C), up to 5 at. % of silicon (Si), up to 5 at. %, in total, of one or more of vanadium (V) and hafnium (Hf), up to 2 at. %, in total, of one or more of boron (B) and zirconium (Zr), up to 1 at. %, in total, of magnesium (Mg), calcium (Ca), cerium (Ce) and lanthanum (La), up to 1 at. % of nitrogen (N), and up to 10 vol. % of at least one ceramic material.

In one approach, the composition of the feedstock is generally consistent during at least a portion of the build of the additive manufacturing of the alloy body. Even though the feedstock has generally the same composition, controlled solidification of a first melt pool at a first solidification rate may realize the first region, and controlled solidification of second melt pool may realize the second region, wherein at least one of the first and second regions comprises the multi-phase microstructure. FIGS. 2a-2c, and their corresponding description, above, illustrate one manner of preparing such alloy bodies. Further, solidification rate(s) can be controlled via the methods and apparatus described above. In one embodiment, a first region comprises a first chemistry and the second region comprises a second chemistry different than the first chemistry. In another embodiment, the first and second regions comprise the same chemistry, but different crystallographic microstructures. In one embodiment, at least 3 vol. % of the final product is of an fcc phase, which may facilitate reducing the tendency for cracking in the solidified material.

In another approach, the composition of the feedstock can be varied, as appropriate, to produce the alloy body having the first and second regions, wherein at least one of the first and second regions comprises a multi-phase microstructure. In this regard, a first feedstock may comprise a first composition and a second feedstock may comprises a second composition, different than the first. At least one of the first and second feedstocks comprises a composition capable of producing a multi-phase microstructure under appropriate production conditions. In one embodiment, a first feedstock is a multi-phase feedstock, capable of producing a multi-phase microstructure (i.e., a matrix having at least two different crystalline phases, as defined above). In one embodiment, a second feedstock is a single-phase feedstock, capable of producing a single-phase microstructure (i.e., a matrix generally consisting of a single crystalline phase, as defined above). In one embodiment, both the first and second feedstocks are multi-phase feedstocks, each capable of producing different multi-phase microstructures.

Some examples of methods of additively manufacturing alloy bodies from multi-component alloy feedstocks are disclosed in commonly-owned International Patent Publication No. WO2017/200985, entitled “Multi-Component Alloy Products, and Methods of Producing the Same,” filed Sep. 9, 2016, which is incorporated herein by reference in its entirety. The various additive manufacturing apparatus also described in this patent application (International Patent Publication No. WO2017/200985) may be used to produce the additively manufactured alloy bodies having the first and second regions with the first and second microstructures, respectively.

As may be appreciated, one or more additives (e.g., ceramic materials) may be used within the alloy body. As one example, the alloy body may include a high volume fraction of one or more additives (e.g., 1-30 vol. % of ceramic phase) within the alloy body, the alloy body still having the first region(s) and the second region(s) with the first and second microstructures, respectively. This high volume fraction of ceramic may be realized via one or more appropriate feedstocks, as disclosed in commonly-owned PCT Patent Application Publication No. WO2016/145382, and the portions of this PCT Patent Application describing ceramic phases and how to introduce them into alloy bodies during additive manufacturing, whether in-situ or otherwise, are incorporated herein by reference. In one embodiment, the alloy body is a metal-matrix composite comprising the first region(s) and the second region(s) with the first and second microstructures, respectively, and with 1-30 vol. % of ceramic phases therein.

As another example, the alloy body may include a low volume fraction of ceramic material (e.g., 0.1-0.9 vol. % of ceramic phase) within the alloy body, the alloy body still having the first region(s) and the second region(s) with the first and second microstructures, respectively. This low volume fraction of ceramic material may be realized via one or more appropriate feedstocks, as disclosed in commonly-owned U.S. Provisional Patent Application No. 62/558,197, and the portions of this Provisional patent application describing ceramic phases and how to introduce them into alloy bodies during additive manufacturing, whether in-situ or otherwise, are incorporated herein by reference. In one embodiment, the alloy body comprises the first region(s) and the second region(s) with the first and second microstructures, respectively, and with 0.1-0.9 vol. % of ceramic phases therein.

In one embodiment, the feedstock comprises at least some ceramic material. The ceramic material may facilitate, for instance, production of crack-free additively manufactured alloy products. In one embodiment, the feedstock comprises a sufficient amount of the ceramic material to facilitate production of a crack-free additively manufactured alloy product. The ceramic material may facilitate, for instance, production of an additively manufactured alloy product having generally equiaxed grains. Too much ceramic material may decrease the strength of the additively manufactured alloy product. Thus, in some embodiments the feedstock comprises a sufficient amount of the ceramic material to facilitate production of a crack-free additively manufactured alloy product (e.g., via equiaxed grains), but the amount of ceramic material in the feedstock is limited so that the additively manufactured alloy product retains its strength (e.g., within 1-2 ksi of its strength without the ceramic). In some embodiments, the amount of ceramic material may be limited such that the strength of the alloy product substantially corresponds to its strength without the ceramic material (e.g., within 5 ksi; within 1-4 ksi). In some embodiments, the amount of ceramic material may be limited such that the strength of the alloy product substantially corresponds to its strength without the ceramic material (e.g., within 5%).

Some examples of ceramics include oxide materials, boride materials, carbide materials, nitride materials, silicon materials, carbon materials, and/or combinations thereof. Some additional examples of ceramics include metal oxides, metal borides, metal carbides, metal nitrides and/or combinations thereof. Additionally, some non-limiting examples of ceramics include: TiB, TiB₂, TiC, SiC, Al₂O₃, BC, BN, Si₃N₄, Al₄C₃, AlN, their suitable equivalents, and/or combinations thereof.

In one embodiment, an alloy product comprises 0.01-10 vol. % of at least one ceramic phase. In another embodiment, an alloy product comprises 0.01-5.0 vol. % of at least one ceramic phase. In yet another embodiment, an alloy product comprises 0.01-3.0 vol. % of at least one ceramic phase. In another embodiment, an alloy product comprises 0.01-1.0 vol. % of at least one ceramic phase. In yet another embodiment, an alloy product comprises 0.1-1.0 vol. % of at least one ceramic phase. In another embodiment, an alloy product comprises 0.5-3.0 vol. % of at least one ceramic phase. In yet another embodiment, an alloy product comprises 1.0-3.0 vol. % of at least one ceramic phase. In one embodiment, an alloy product comprises at least one ceramic material, wherein the at least one ceramic material comprises TiB₂.

V. Control of Exposure History within the Additive Manufacturing Apparatus

Once the first and second regions are prepared, it may be useful to maintain those regions during further additive manufacturing of the alloy body, or purposefully change the first region(s) and/or the second region(s), by managing the exposure history of the alloy body having the prepared first and second regions. In this regard, and as described above in Section I, the thermal exposure history and/or pressure exposure history of these regions may be managed/controlled to facilitate maintenance these regions, or purposeful transformation of one or more of these regions to a new matrix having a different crystallographic structure. See Section I, above, for particular manners of realizing appropriate thermal and/or pressure exposure histories.

In one approach, a method comprises controlling environmental conditions relative to (e.g., within) the additive manufacturing apparatus during the additive manufacturing thereby at least partially maintaining the first and second regions. In one embodiment, controlling the environmental conditions at least includes controlling a temperature history of the alloy body during the additive manufacturing, thereby at least partially maintaining the first and second regions. In one embodiment, controlling the temperature history include controlling a temperature of at least a portion of a base platen of the additive manufacturing apparatus. In one embodiment, controlling the temperature history includes controlling fluid conditions surrounding the alloy body (e.g. controlling gas conditions). In one embodiment, controlling the temperature history includes controlled heating of the alloy body followed by controlled quenching of the alloy body via a quench media, thereby at least partially maintaining the first and second regions.

In another approach, controlling the environmental conditions comprises controlling pressure of the additive manufacturing apparatus during the additive manufacturing. In one embodiment, controlling the pressure includes maintaining a vacuum or an elevated pressure within the additive manufacturing apparatus. While under vacuum or at elevated pressure, at least a portion of the alloy body may be heated (e.g., via radiative heating) to at partially maintain the first and second regions. This radiative heating may heat applicable portions of the alloy body within a predetermined percentage of its solidus temperature, but below its solidus temperature.

In another approach, a method comprises controlling environmental conditions relative to (e.g., within) the additive manufacturing apparatus during the additive manufacturing thereby purposefully changing a matrix of at least one of the first region or second region to another matrix having a different crystallographic structure. In one embodiment, controlling the environmental conditions at least includes controlling a temperature history of the alloy body during the additive manufacturing, thereby changing at least one of the first and second regions. In one embodiment, controlling the temperature history include controlling a temperature of at least a portion of a base platen of the additive manufacturing apparatus. In one embodiment, controlling the temperature history includes controlling fluid conditions surrounding the alloy body (e.g. controlling gas conditions). In one embodiment, controlling the temperature history includes controlled heating of the alloy body followed by controlled quenching of the alloy body via a quench media, thereby at least changing at least one of the first and second regions.

In another approach, controlling the environmental conditions comprises controlling pressure of the additive manufacturing apparatus during the additive manufacturing. In one embodiment, controlling the pressure includes maintaining a vacuum or an elevated pressure within the additive manufacturing apparatus. While under vacuum or at elevated pressure, at least a portion of the alloy body may be heated (e.g., via radiative heating) to change the matrix of at least one the first and second regions to another matrix having a different crystallographic structure. This radiative heating may heat applicable portions of the alloy body within a predetermined percentage of its solidus temperature, but below its solidus temperature.

In one approach, after solidification of a melt pool, exposure is used to purposefully transform a first region into a second region. For instance, global or localized thermal exposure may be used to transform a single phase region (e.g., a bcc region) to a multi-phase region (e.g., an fcc+bcc region). This thermal exposure may be completed during the additive manufacturing (e.g., purposefully or incidentally), as described above, or this thermal exposure may be completed after the additive manufacturing has been completed, as described below.

### VI. Post-Production Treatments

Once the alloy body has been completed via the additive manufacturing apparatus, the final alloy body may be post-production treated. In one embodiment, a method includes removing the final alloy body from the additive manufacturing apparatus, and conducting external processing on the final alloy body. In one embodiment, the external processing comprises thermal processing (TP), thermomechanical processing (TMP), or mechanical processing (MP) of the alloy body. For instance, a post-production treatment may be conducted on the final alloy body to facilitate achievement of the appropriate product form having the appropriate regions therein.

As one example, at least one of the first and second regions of the final alloy body may comprise a metastable microstructure (whether multi-phase or single phase). Post-production treatments, such as any of TP, TMP or MP, may be used to facilitate reversion (e.g., controlled reversion) of at least some of these metastable microstructures to its more stable form (e.g., reversion of single-phase back to multi-phase; reversion of multi-phase back to single-phase). In one embodiment, TMP is used to purposefully revert the matrix of one or more of the second regions back to the crystallographic structure of the first region. In one embodiment, TMP is used to purposefully change the matrix of one or more of the second regions to a crystallographic structure different than that of either the first region or the second region. For example, working the alloy body at elevated temperature may facilitate purposeful changing or reversion of the matrix of one or more of the second regions.

The final alloy body may be a predetermined preform having a predetermined initial configuration, and the post-production processing may be used to change the preform from its predetermined initial configuration to a predetermined final configuration. For instance, TP could be used to change the preform to its final configuration (e.g., having changed the matrix of at least one of the first and second regions), the final configuration having a different microstructure but generally the same shape and volume as the initial configuration. As another example, TMP or MP may be used to change the preform to its final configuration, the final configuration having a different shape and volume than the initial configuration. The first and second regions, having the first and second microstructures where one is a multi-phase microstructure, may be maintained or modified during any of the TP, TMP or MP steps. The predetermined final configuration may be a configuration supplied to a customer, such as an aerospace or automotive customer, as described below. Alternatively, the predetermined initial configuration may be supplied to the customer, who completes the post-production treatments.

The post-production treatments may include working (hot and/or cold working) so as to facilitate stress-relief of the final alloy body and/or production of wrought products. In another embodiment, the post-production treatments are free of working, leaving the final alloy body in its additively manufactured configuration, and only TP is completed. Other post-production treatments may be used, such as precipitation hardening, homogenization, and grain growth or reduction, among others.

The final product may include any applicable combination of first regions and second regions. In one embodiment, the final product comprises fcc and bcc microstructures. In one embodiment, the final product is absent of an HCP microstructure. In another embodiment, the final product is absent of an orthorhombic microstructure. In another embodiment, the final product is absent of a tetragonal microstructure. In one embodiment, the final product consists essentially of fcc and bcc microstructures.

### VII. Applications

The multi-region products having at least one multi-phase microstructure region may be used in any suitable product application. In one embodiment, a multi-region product is an aerospace product, wherein the first region has properties suited for a first aerospace condition, and the second region has properties suited for a second aerospace condition, different than the first (e.g., strength v. ductility; strength v. corrosion resistance; fracture toughness v. strength; fracture toughness v. corrosion resistance, strength retention at elevated temperature v. ductility).

In another embodiment, a multi-region product is an automotive product, wherein the first region has properties suited for a first automotive condition, and the second region has properties suited for a second automotive condition, different than the first (e.g., strength v. ductility; strength v. corrosion resistance; strength retention at elevated temperature v. ductility).

In another embodiment, a multi-region product is a defense product (e.g., armor), where the first region has properties suited for a first defense condition, and the second region has properties suited for a second defense condition, different than the first (e.g., strength v. ductility; strength v. corrosion resistance).

VIII. Initial Product with Single Phase(s)

As described above, additive manufacturing may be used to produce tailored multi-phase products having a first region with a first crystallographic structure and one or more second regions generally have a second crystallographic structure, different than the first, where at least one of the first and second crystallographic structures is a multi-phase microstructure. In an alternative embodiment, additive manufacturing may be used to produce a single-phase product consisting essentially of the first region (e.g., due to control of the solidification rate(s) and/or thermal/pressure exposure history of the product, as described above). In one embodiment, the first region consists essentially of an fcc microstructure. In one embodiment, during the additive manufacturing, the solidification rate(s) are maintained at or above a threshold solidification rate (e.g., a predetermined threshold solidification rate) so as to realize the first region having the fcc microstructure. In one embodiment, the first region consists essentially of a bcc microstructure. In one embodiment, during the additive manufacturing, the solidification rate(s) are maintained at or above a threshold solidification rate (e.g., a predetermined threshold solidification rate) so as to realize the first region having the bcc microstructure. After production of the additively manufacturing product having the first region, appropriate thermal/pressure exposure history (per Section V, above) and/or post-production treatments (per Section, VI, above) may be used to transform at least some of the first region into one or more second regions. For instance, localized/tailored exposure conditions (e.g., via a platen or surrounding atmospheric) may be used to convert at least some of a first region (e.g., of an fcc structure; of a bcc structure) to a second region (e.g., of a bcc structure; of a fcc structure), as described above.

In another embodiment, additive manufacturing and corresponding controlled solidification rates and/or thermal exposure history may be used to produce an additively manufactured product having two single phase regions, with each region having its own microstructure (e.g., a first region of fcc and a second region of bcc). In this regard, the first region has a first lattice parameter, and the second region has a second lattice parameter, different than the first lattice parameter. In one embodiment, a first predetermined solidification rate is used to produce the first region, and a second predetermined solidification rate is used to produce the second region. In one embodiment, each of the first and second regions has a size of at least 50 microns. In one embodiment, one or both of these first and second single phase regions are transformed to a multi-phase region due to subsequent processing (e.g., due to purposeful thermal exposure). In another embodiment, one or both of these first and second single phase regions are maintained (e.g., neither the first nor the second phase regions are transformed).

### BRIEF DESCRIPTION OF THE DRAWINGS

FIG. 1 is a schematic, cross-sectional view of one embodiment of an additively manufactured alloy body having a first region and a plurality of second regions (not to scale).

FIGS. 2a-2c are schematic, cross-sectional views of one manner of producing different microstructural regions within an additively manufactured product (not to scale).

FIGS. 3a-3f are schematic, cross-sectional views of various embodiments of additively manufactured bodies having a first region and a plurality of second regions (not to scale.)

FIG. 4 is an SEM micrograph of Alloy 2 from Example 1 showing a crack.

FIG. 5 is an SEM micrograph at 500× magnification of Sample A-14 from Example 2; the microstructure shows a predominantly bcc crystalline structure.

FIG. 6 is an SEM micrograph at 10,000× magnification of Sample A-15 from Example 2; the microstructure shows a mixed fcc+bcc crystalline structure.

FIG. 7 is an SEM micrograph at 10,000× magnification of Sample A-16 from Example 2; the microstructure shows fcc crystalline structures within the bcc crystalline structures.

FIG. 8a is an SEM micrograph at 500× magnification of Sample A-17 from Example 2; the microstructure shows a predominantly bcc crystalline structure.

FIG. 8b is a portion of FIG. 9a at 8,000× magnification; fcc crystalline structures are located along the boundaries of the bcc crystalline structures.

FIG. 9 is an SEM micrograph at 5,000× magnification of Sample A-18 from Example 2; the microstructure shows fcc crystalline structures located along the boundaries of the bcc crystalline structures, and fcc crystalline structures within the bcc crystalline structures, and generally equiaxed crystalline structures (grains).

FIG. 10 is an SEM micrograph at 5,000× magnification of Sample A-19 from Example 2; the microstructure shows fcc crystalline structures located along the boundaries of the bcc crystalline structures, and fcc crystalline structures within the bcc crystalline structures, and generally equiaxed crystalline structures (grains).

FIG. 11a is an SEM micrograph at 500× magnification of Sample A-20 from Example 2; the microstructure shows a mixed fcc+bcc crystalline structure.

FIG. 11b is a portion of FIG. 12a at 10,000× magnification.

FIG. 12a is an SEM micrograph at 500× magnification of Sample A-21 from Example 2; the microstructure shows a mixed fcc+bcc crystalline structure.

FIG. 12b is a portion of FIG. 13a at 10,000× magnification.

FIG. 13 illustrates the matrix vol. % of fcc crystalline structures versus the solidification rate for as-solidified Alloy A from Example 2.

FIG. 14 illustrates the matrix vol. % of fcc crystalline structures versus the solidification rate for as-solidified Alloy 6 from Example 1.

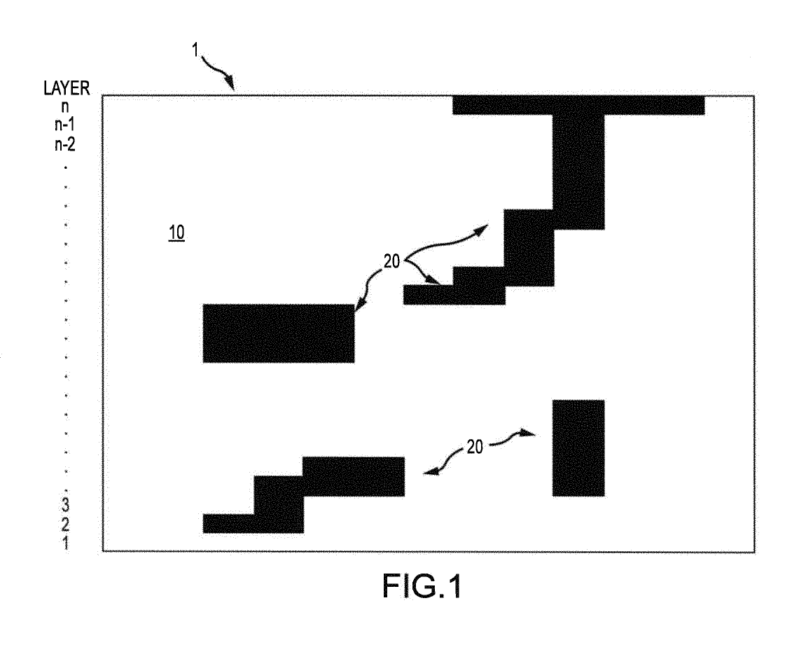

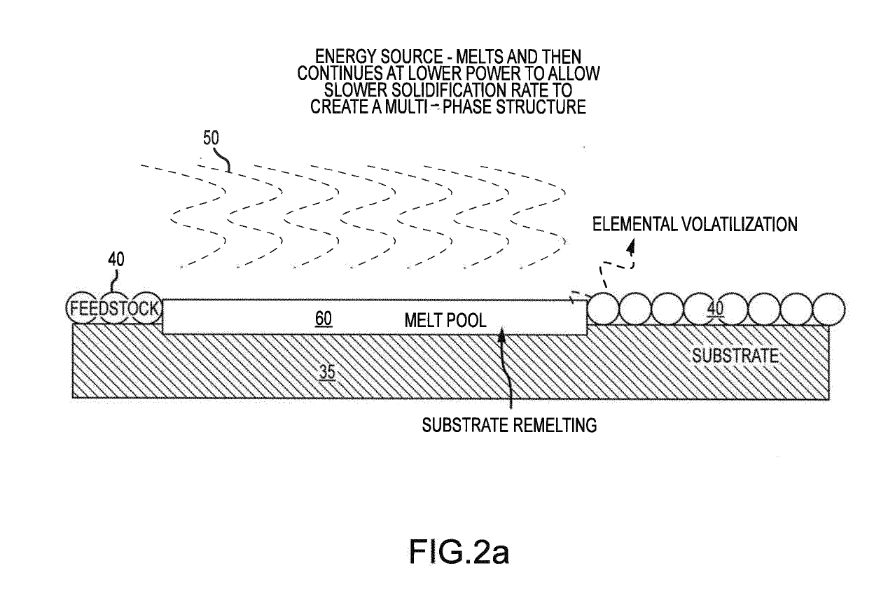

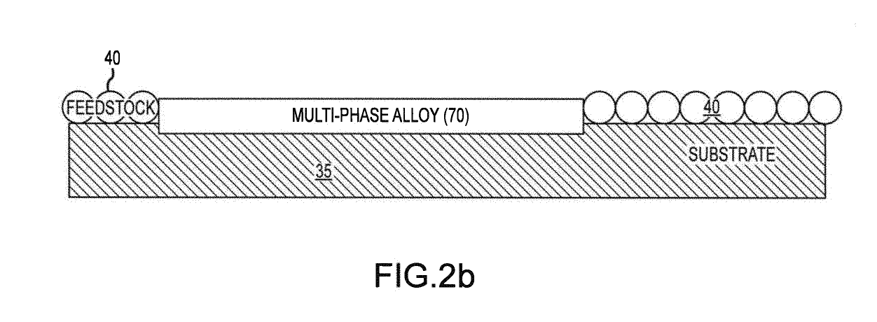

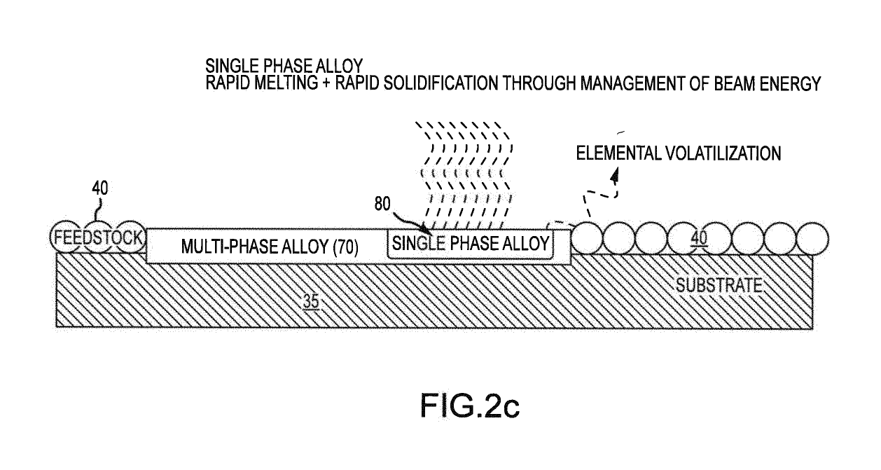

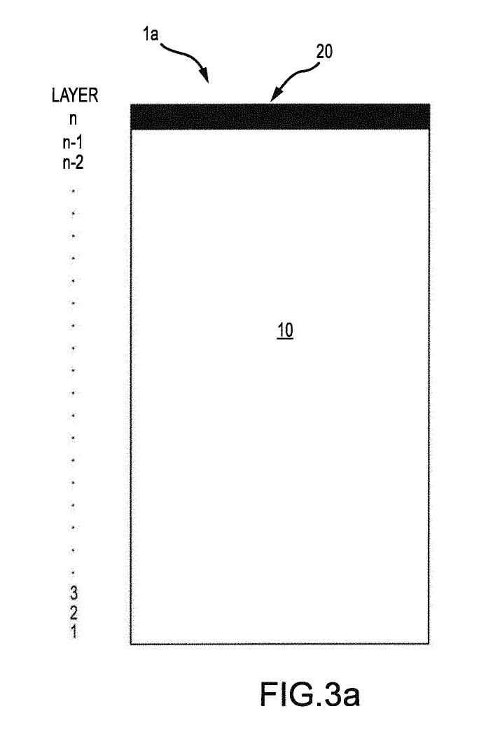

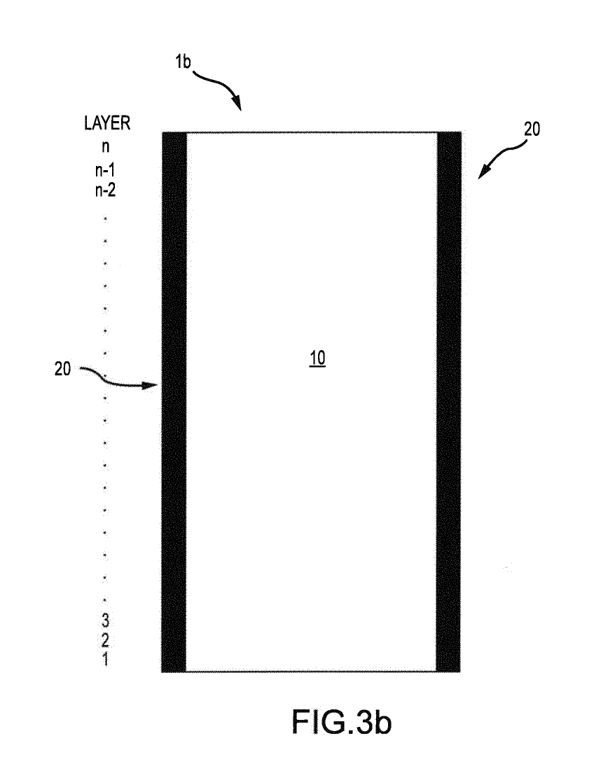

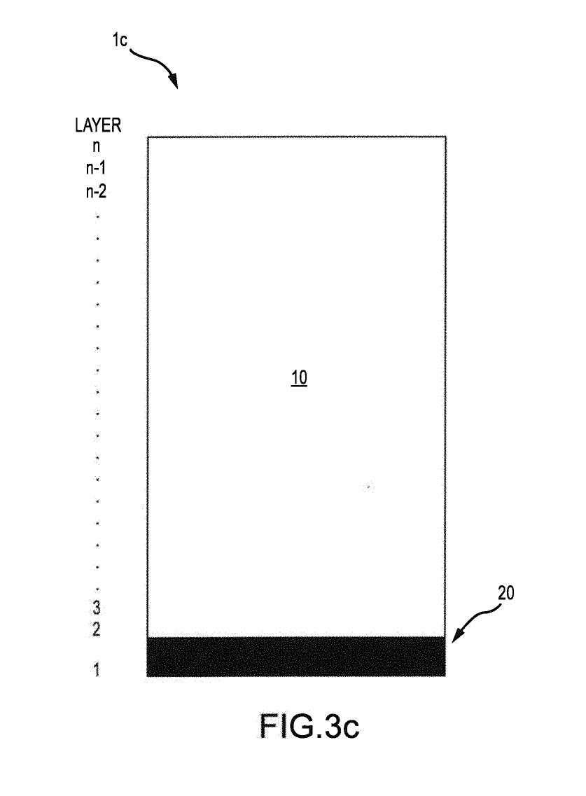

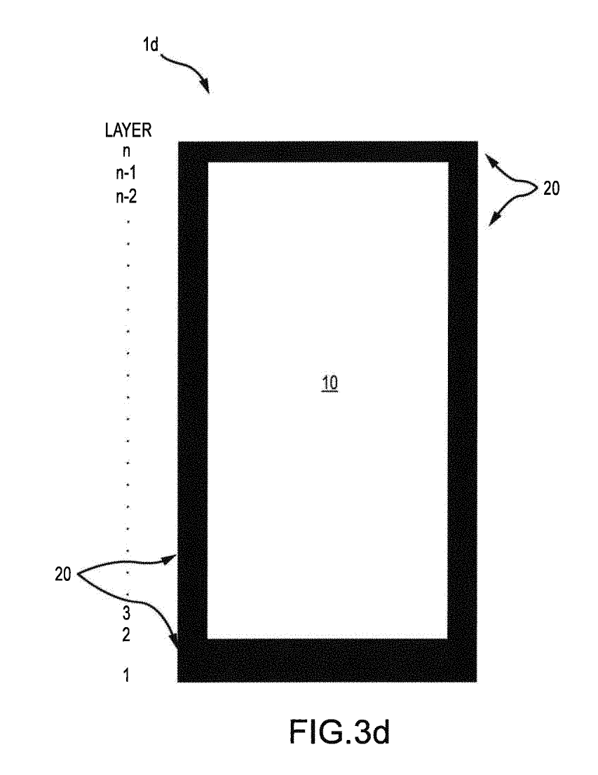

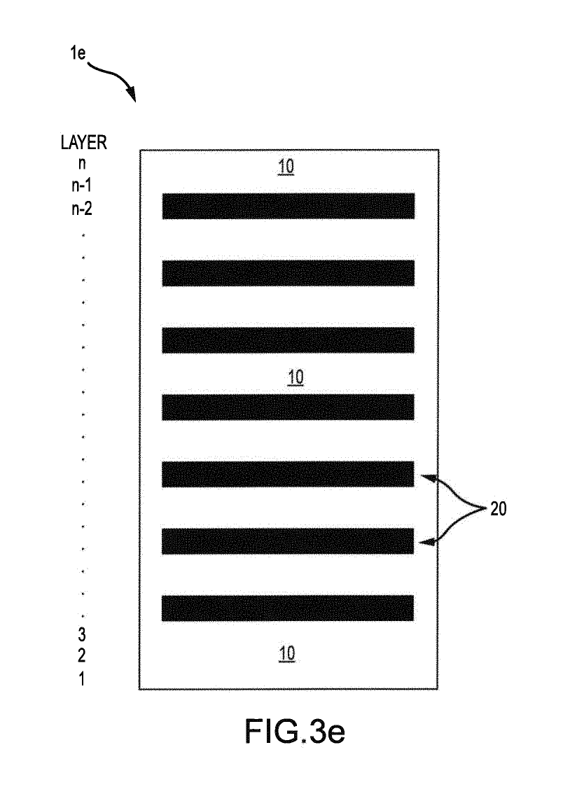

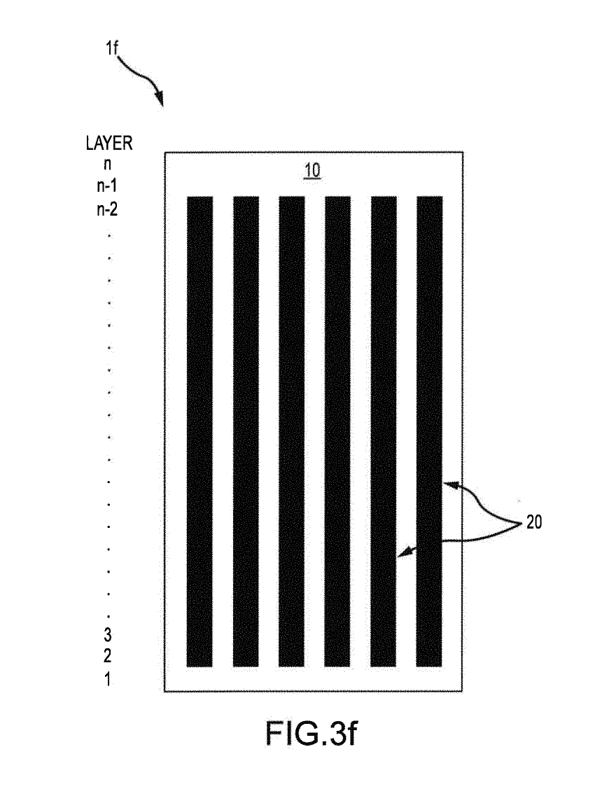

### DETAILED DESCRIPTION

### Example 1

Seventeen experimental alloys were produced having the nominal compositions given in Table 1A, below. Furthermore, densities of the alloys measured by Archimedes method are given in Table 1A, below.

TABLE 1A
Nominal Compositions of Example 1 Alloys (in at. %)

| Alloy | | | | | | | | | | | Density |
|---|---|---|---|---|---|---|---|---|---|---|---|
| No. | Ni | Fe | Cr | Al | Ti | Nb | B | C | Hf | Zr | (g/cm³) |
| 1 | Bal. | 32 | 20 | 14 | 1 | — | — | — | — | — | 7.3 |
| 2 | Bal. | 32 | 20 | 13 | 1 | 1 | — | — | — | — | 7.4 |
| 3 | Bal. | 30 | 20 | 7.5 | 7.5 | — | — | — | — | — | 7.5 |
| 4 | Bal. | 32 | 20 | 9 | 1 | 3 | — | — | — | — | 7.6 |
| 5 | Bal. | 28 | 18 | 12 | 3 | 1 | — | — | — | — | 7.6* |
| 6 | Bal. | 28 | 18 | 12 | 3 | 1 | 0.05 | 0.2 | — | — | 7.6* |
| 7 | Bal. | 30 | 20 | 7.5 | 7.5 | — | 0.05 | 0.21 | — | — | 7.4 |
| 8 | Bal. | 30 | 20 | 7.5 | 7.5 | — | 0.05 | 0.21 | 0.15 | 0.06 | 7.4* |
| 9 | Bal. | 30 | 20 | 14 | 1 | — | — | — | — | — | 7.3 |
| 10 | Bal. | 30 | 20 | 11 | 4 | — | — | — | — | — | 7.4 |
| 11 | Bal. | 30 | 20 | 6 | 6 | — | — | — | — | — | 7.6 |
| 12 | Bal. | 30 | 20 | 9 | 9 | — | — | — | — | — | 7.6 |
| 13 | Bal. | 32 | 20 | 13 | 1 | 1 | 0.05 | 0.21 | 0.15 | 0.06 | 7.3 |
| 14 | Bal. | 32.7 | 20 | 14 | — | — | — | — | — | — | 7.4* |
| 15 | Bal. | 32.7 | 19.9 | 14 | — | — | — | 0.9 | — | — | 7.3* |
| 16 | Bal. | 31.8 | 19.3 | 13.6 | — | — | — | 4.2 | — | — | 7.2* |
| 17 | Bal. | 29.8 | 18.1 | 12.7 | — | — | — | 11.8 | — | — | 6.8* |

*Estimated based on alloy of similar composition.
**Bal. = the balance of the alloy was nickel.

Some of the experimental alloys were cast as rectangular ingots (0.5 inch×0.5 inch×3 inches) for tensile property evaluation. The ingots were cut into cylindrical specimens of 1.5 inches in length and 0.2 inch in diameter using electrical discharge machining. The cylindrical specimens were then lathed into standard testing blanks, each having a larger cylindrical shoulder at each end and a smaller cylindrical gage section in between the shoulders. Some of the testing blanks were heat treated prior to tensile testing as described in Tables 1B and 1C, below.

### Room Temperature Tensile Properties

The room temperature tensile properties (tensile yield strength (TYS), ultimate tensile strength (UTS), elongation, and specific yield strength) of some experimental alloys were evaluated in the as-cast condition, while others were evaluated after thermal processing. The evaluation was performed in the longitudinal direction and in accordance with ASTM E8 (rev. #8M-16A). Results from the evaluation are given in Table 1B, below.

TABLE 1B
Room Temperature Tensile Testing Results

| | | | | | Specific Yield |
|---|---|---|---|---|---|
| Alloy | Thermal | TYS | UTS | Elongation | Strength |
| No. | Treatment (if any) | (ksi) | (ksi) | (%) | (ksi*in³/lbs) |
| 1 | Type 1 | 152 | 207 | 13 | 576 |
| 9 | Type 2 | 108 | 179 | 13.3 | 405 |
| 10 | Type 2 | 143 | 188 | 4.4 | 533 |
| 3 | Type 2 | 173 | 194 | 2.2 | 640 |
| 11 | Type 2 | 164 | 178 | 2.2 | 607 |
| 1 | N/A - As-cast | 113 | 186 | 20 | 428 |
| 3 | N/A - As-cast | 128 | 151 | 2.2 | 472 |
| 9 | N/A - As-cast | 92 | 171 | 18.9 | 342 |
| 10 | N/A - As-cast | 97 | 170 | 16.7 | 362 |
| 11 | N/A - As-cast | 120 | 167 | 13.3 | 441 |

### Elevated Temperature Tensile Properties

The elevated temperature (650° C.) tensile properties of some experimental alloys were evaluated after thermal treatment. The evaluation was performed in the longitudinal direction, and in accordance with ASTM E21-09. Results from the evaluation are given in Table 1C, below.

TABLE 1C
Elevated Temperature (650° C.) Tensile Testing Results

| | | | | | Specific Yield |
|---|---|---|---|---|---|
| Alloy | Thermal | TYS | UTS | Elongation | Strength |
| No. | Treatment | (ksi) | (ksi) | (%) | (ksi*in³/lbs) |
| 2 | Type 1 | 106 | 138 | 36 | 396 |
| 3 | Type 2 | 140 | 169 | 20 | 517 |
| 4 | Type 1 | 122 | 161 | 25 | 444 |
| 5 | Type 2 | 130 | 164 | 25 | 473 |
| 9 | Type 2 | 69 | 99 | 31 | 260 |
| 10 | Type 2 | 105 | 137 | 30 | 393 |

### Solidification Rate Evaluation

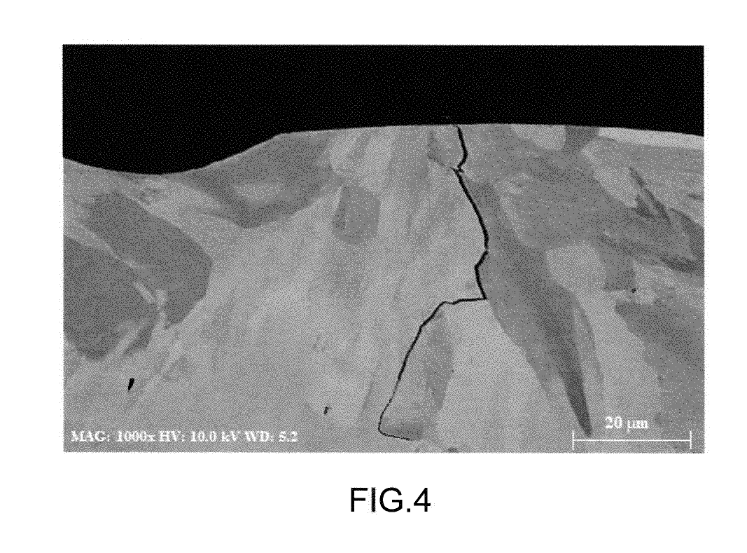

The experimental alloys were solidified by two methods that realize solidification rates on the order of 1,000,000° C./s and 10,000-100,000° C./s. Following solidification, the tendency for the material to crack at the employed solidification rate was evaluated in the as-solidified condition. The tendency for the material to crack was evaluated by (1) visual inspection (e.g., with the human eye) and/or (2) micrograph inspection. In this regard, the experimental alloys were evaluated on a qualitative pass/fail rating, where a pass rating indicates the as-solidified material was free of cracks and a fail rating indicates the material contained at least one crack. The as-solidified materials were first analyzed by visual inspection. If it was apparent from visual inspection that the solidified material contained cracks, the alloy was given a rating of “fail”. If the material appeared to have no cracks by visual inspection, appropriate micrographs were taken and analyzed to make the determination. Results from the solidification evaluations are given in Table 1D, below. An example micrograph of Alloy 2, having been solidified at approximately at 1,000,000° C./s is given in FIG. 4. As illustrated in FIG. 4, a crack near the surface of the material can be seen at 1,000× magnification. An example micrograph of Alloy 1 having been solidified at approximately 10,000° C./s is given in FIG. 9. As illustrated in FIG. 9, the material is free of cracks.

TABLE 1D
Solidification Experiment Cracking Evaluation Results

| Alloy | | | Solidification |
|---|---|---|---|
| No. | 1,000,000° C./s | 10,000-100,000° C./s | Pathway⁽*⁾ |
| 1 | Fail | Pass | near-eutectic |
| 2 | Fail | Fail | near eutectic |
| 3 | Pass | Pass | fcc-first |
| 4 | Pass | Pass | fcc-first |
| 5 | Pass | Pass | fcc-first |
| 6 | Pass | Pass | fcc-first |
| 7 | Pass | Pass | fcc-first |
| 8 | Pass | Pass | fcc-first |
| 9 | Pass | Pass | fcc-first |
| 10 | Pass | Pass | fcc-first |
| 11 | Pass | Pass | fcc-first |
| 12 | Pass | Pass | fcc-first |
| 13 | Fail | Fail | near eutectic |
| 14 | N/A | N/A | N/A |
| 15 | Pass | Pass | fcc-first |
| 16 | Pass | Pass | bcc-first |
| 17 | Fail | Fail | bcc-first |

⁽*⁾Near-eutectic solidification pathway reflects a solidification pathway where fcc and bcc generally form from the liquid generally concomitantly (i.e., neither an fcc-first or bcc-first solidification pathway). A bcc-first solidification pathgiway reflects a solidification pathway where bcc crystalline structures form first from the liquid prior to the formation of fcc crystalline structures. An fcc-first solidification pathway reflects a solidification pathway where fcc crystalline structures form first from the liquid prior to the formation of bcc crystalline structures.

### Example 2

### Tensile Properties Evaluation

Three additional experimental alloys were cast as ingots (0.5 inch×0.5 inch×3 inch). The nominal compositions of the three additional experimental alloys are given in Table 2A, below. Alloy A has the same nominal composition as Alloy 1 of Example 1, above. Alloy B is a prior art alloy from Dong, Y., Gao, X., Lu, Y., Wang, T.,& Li, T (2016). “A multi-component AlCrFe2Ni2 alloy with excellent mechanical properties” Materials Letters, 169, 62-64, and Alloy C is a prior art alloy from Dong, Y., Lu, Y. Kong, J., Zhang, J., & T. (2013). “Microstructure and mechanical properties of multi-component AlCrFeNiMox high-entropy alloys” Journal of Alloys and Compounds, 573, 96-101.

TABLE 2A
Nominal Compositions of Experimental Alloys A, B, and C

| Alloy No. | Ni | Fe | Cr | Al | Ti |
|---|---|---|---|---|---|
| A | 33 | 32 | 20 | 14 | 1 |
| (Inv.) | | | | | |
| B | 33.3 | 33.3 | 16.7 | 16.7 | Trace |
| (Prior Art) | | | | | |
| C | 25 | 25 | 25 | 25 | Trace |
| (Prior Art) | | | | | |

Following casting, some ingots of Alloy A and B were cut in the longitudinal direction into rectangular samples (0.25 inch×0.5 inch×3 inches) in preparation for rolling. The samples were heated to 900° C. and hot rolled, in six passes, to a net relative reduction of approximately 55%. The wrought samples were examined for edge cracking. Alloy A appeared to be free of cracks, while Alloy B exhibited severe edge cracking. Alloy A was therefore in a condition for further testing, described below.

### Wrought Samples

Four specimens (A-1 through A-4) from the Alloy A ingots were thermally treated, after which, room temperature tensile properties were measured in the longitudinal direction and in accordance with ASTM E8 (rev. #8M-16A). The results from the evaluation are given in Table 2B, below.

TABLE 2B
Wrought Room Temperature Tensile Properties of Alloy A

| Sample | Thermal | TYS | UTS | Elong. |
|---|---|---|---|---|
| No. | Treatment | (ksi) | (ksi) | (%) |
| A-1 | Practice #1 | 124 | 169 | 17 |
| A-2 | Practice #2 | 161 | 196 | 10 |
| A-3 | Practice #3 | 142 | 182 | 8 |
| A-4 | Practice #4 | 108 | 158 | 21 |

### Non-Wrought Samples

Four specimens (A-5 through A-8) from the Alloy A ingots and four specimens (C-1 through C-4) from the Alloy C ingots were thermally treated, after which room temperature tensile properties of heat treated samples were measured in accordance with ASTM E8 (rev. #8M-16A). Samples of Alloy C were thermally treated in an argon atmosphere to prevent oxidation. As illustrated in Table 2C, the samples of Alloy C failed before yielding. Thus, only the ultimate tensile strength was measured for the Alloy C samples, and no further samples were evaluated due to the poor ductility.

TABLE 2C
As-Cast Room Temperature Tensile Properties of Alloy A and C

| Sample | Thermal | TYS | UTS | Elong. |
|---|---|---|---|---|
| No. | Treatment | (ksi) | (ksi) | (%) |
| A-5 | Condition #1 | 69 | 153 | 28 |
| A-6 | Condition #2 | 96 | 154 | 12 |
| A-7 | Condition #3 | 116 | 179 | 11 |
| A-8 | Condition #4 | 156 | 212 | 14 |
| C-1 | Condition #5 | — | 116 | 0.0 |
| C-2 | Condition #5 | — | 100 | 0.0 |
| C-3 | Condition #5 | — | 85 | 0.0 |
| C-4 | Condition #5 | — | 103 | 0.0 |

Four additional specimens (A-8 through A-13) from the Alloy A ingots were prepared for tensile testing in the as-cast condition (i.e., without thermal treatment). Sample A-9 was evaluated at room temperature in the longitudinal direction and in accordance with ASTM E8 (rev. #8M-16A). Samples A-10 through A-13 were evaluated in the longitudinal direction at 500° C., 600° C., 650° C., and 700° C., and in accordance with ASTM E21-09. Results from the evaluations are given in Table 2D, below.

TABLE 2D
Tensile Testing Results for As-Cast
Alloy A at Various Temperatures

| Sample | Temperature | TYS | UTS | Elong. |
|---|---|---|---|---|
| No. | (° C.) | (ksi) | (ksi) | (%) |
| A-9 | 25 | 113 | 176 | 13 |
| A-10 | 500 | 97 | 144 | 39 |
| A-11 | 600 | 90 | 116 | 47 |
| A-12 | 650 | 77 | 105 | 26 |
| A-13 | 700 | 58 | 81 | 28 |

### Solidification Rate Evaluations

As noted above, Alloy A was selected for a separate set of solidification rate evaluations. Samples of Alloy A were solidified at rates varying from about 10° C./s to about 1,000,000° C./s. Following solidification, and in some cases post-solidification thermal treatment, the samples were microstructurally characterized. Furthermore, hardness, room temperature tensile properties, and elevated temperature tensile properties (e.g., 450° C. and 650° C.) of the samples were evaluated. The samples conditions (e.g., as-solidified; thermally treated) are given in Table 2E, below.

### Microstructural Characterization

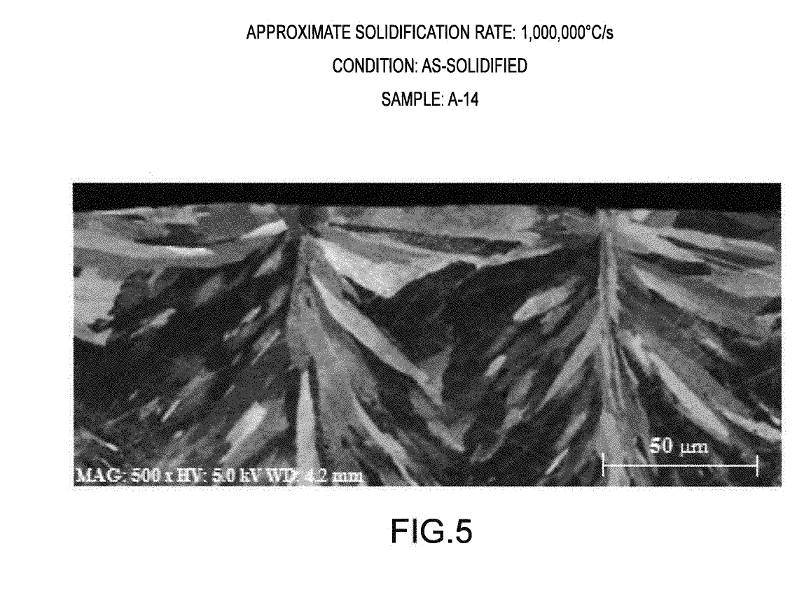

Alloy A was subjected to solidification rates varying from about 10° C./s to about 1,000,000° C./s. Following solidification, and in some cases following post-solidification thermal treatment, appropriate micrographs were taken of the solidified materials. The solidification rate and conditions (e.g., thermal history or as-solidified) are given in Table 2E, below. Additionally, figure numbers of the micrographs are illustrated in FIGS. 5-12b, are given in Table 2E.

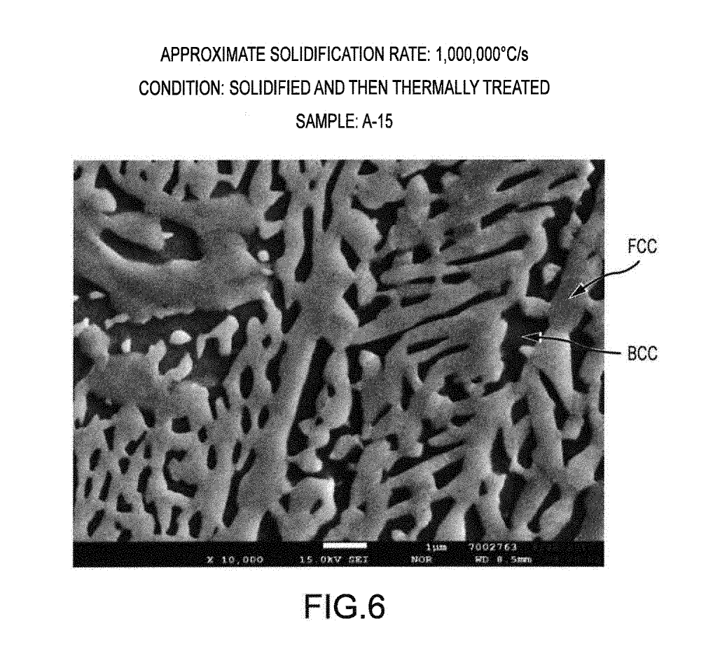

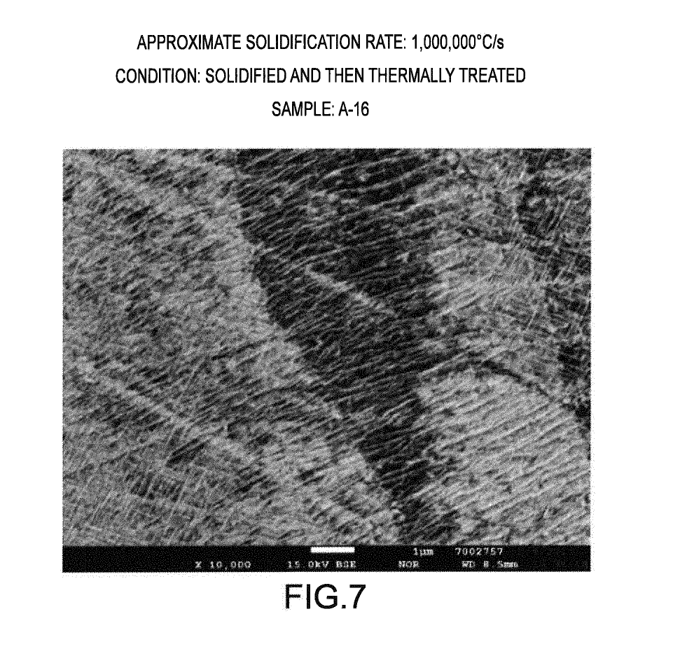

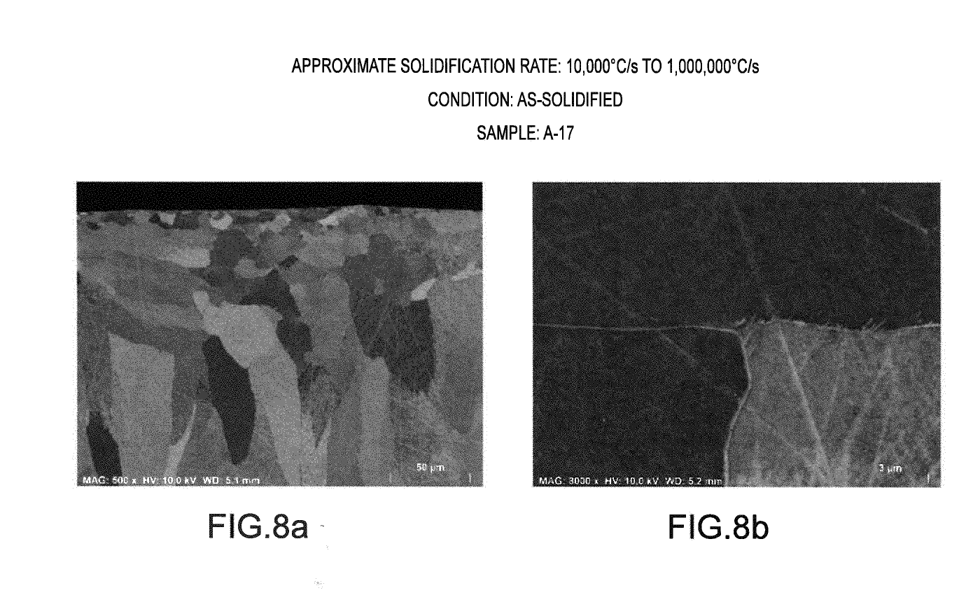

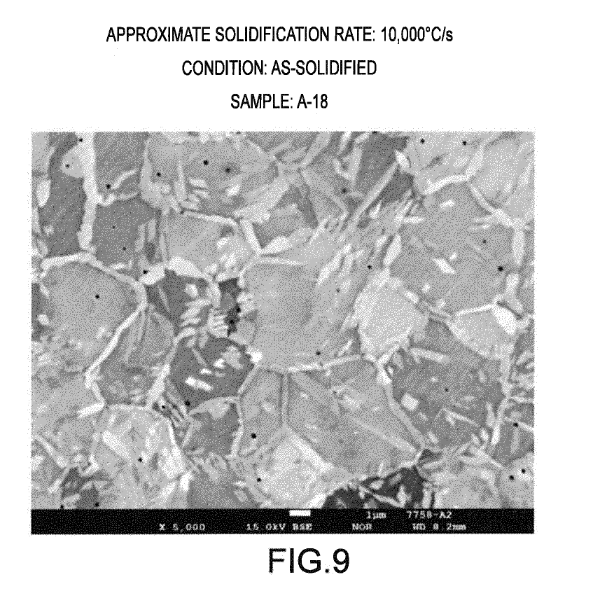

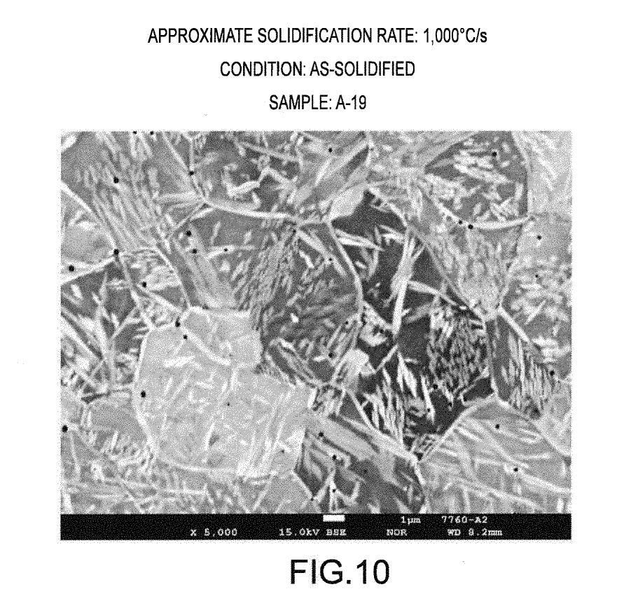

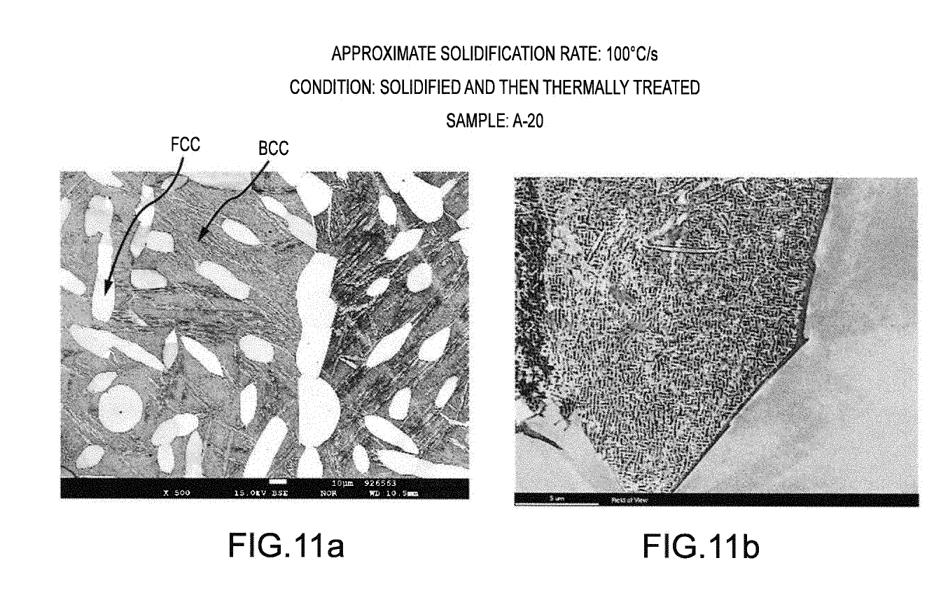

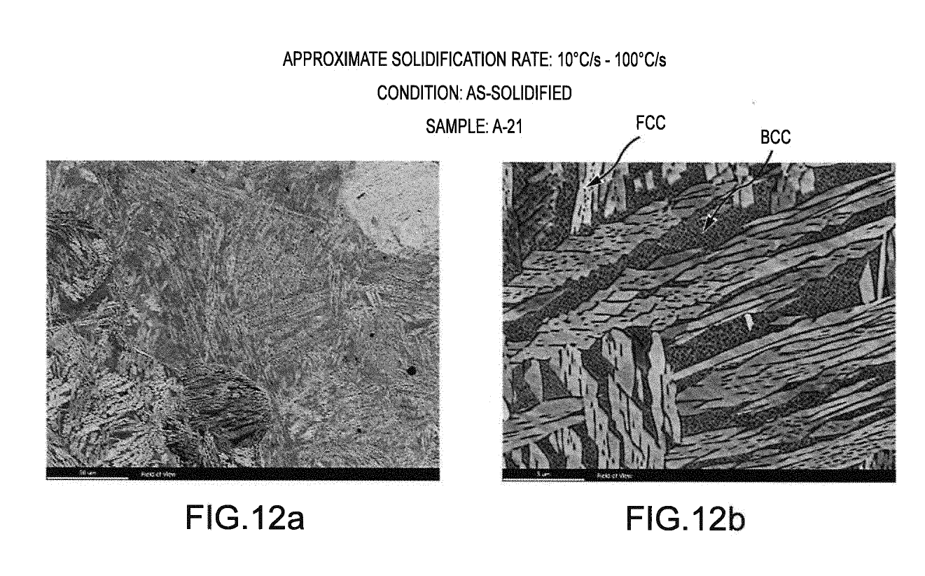

TABLE 2E
Solidification Evaluation

| Sample | Approximate | | | Corresponding |
|---|---|---|---|---|
| No. | Solidification Rate | | Condition | FIG(S). |
| A-14 | 1,000,000° | C./s | As-solidified | FIG. 5 |
| A-15 | 1,000,000° | C./s | Solidified and then | FIG. 6 |
| | | | thermally treated | |
| A-16 | 1,000,000° | C./s | Solidified and then | FIG. 7 |
| | | | thermally treated | |
| A-17 | 10,000° C./s | | As-solidified | FIGS. 8a |
| | to 1,000,000° C./s | | | and 8b |
| A-18 | 10,000° | C./s | As-solidified | FIG. 9 |
| A-19 | 1,000° | C./s | As-solidified | FIG. 10 |
| A-20 | 100° | C./s | Solidified and then | FIGS. 11a |
| | | | thermally treated | and 11b |

| | | | |
|---|---|---|---|
| A-21 | 10° C./s-100° C./s | As-solidified | FIGS. 12a |
| | | | and 12b |

The microstructures shown in FIGS. 5-12b were characterized using Electron Backscatter Diffraction (“EBSD”) to determine the volumetric percentage of matrix fcc and matrix bcc crystalline structures (i.e., phases other than fcc/bcc were not measured or characterized). Elemental compositions within the fcc and bcc crystalline structures were determined using Energy Dispersive X-Ray Spectroscopy (“EDS”). Results from the evaluations are given in Table 2F, below. The micrographs given in FIGS. 5-12b (listed above in Table 2E) were used for the microstructural characterization.

TABLE 2F
Microstructural Analysis of fcc and bcc Crystalline Structures

| | | Matrix | | | | | |
|---|---|---|---|---|---|---|---|
| Sample | | Vol. % | Elemental Composition within Phase (at. %) | | | | |
| No. | Phase | of phase | Al | Cr | Fe | Ni | Ti |
| A-14 | fcc | 0 | — | — | — | — | — |
| | bcc | 100 | 13.1 | 20.3 | 35.1 | 30.3 | 1.2 |
| A-15 | fcc | 73 | 6.5 | 23.4 | 37.3 | 31.9 | 0.9 |
| | bcc | 27 | 19.8 | 11.3 | 21.0 | 46.0 | 1.9 |
| A-16 | fcc | 1 | 9.7 | 20.1 | 34.9 | 34.4 | 0.9 |
| | bcc | 99 | 10.1 | 20.7 | 34.2 | 33.9 | 1.1 |
| A-17 | fcc | 0 | — | — | — | — | — |
| | bcc | 100 | 12.2 | 19.3 | 35.4 | 32.2 | 0.9 |
| A-18 | fcc | 9 | 11.7 | 18.3 | 31.2 | 37.7 | 1.1 |
| | bcc | 91 | 9.8 | 21.4 | 34.3 | 33.4 | 1.1 |
| A-19 | fcc | 46 | 9.9 | 20.4 | 34.2 | 34.4 | 1.1 |
| | bcc | 54 | 9.9 | 20.4 | 34.2 | 34.4 | 1.1 |
| A-20 | fcc | Not | 7.7 | 21.37 | 35.6 | 34.5 | 0.9 |
| | | Measured | | | | | |
| | bcc | Not | 11.4 | 21.3 | 32.1 | 34.1 | 1.1 |
| | | Measured | | | | | |
| A-21 | fcc | 56 | 9.7 | 22.1 | 37.5 | 30.0 | 0.7 |
| | bcc | 44 | 15.3 | 24.1 | 32.1 | 27.7 | 0.8 |

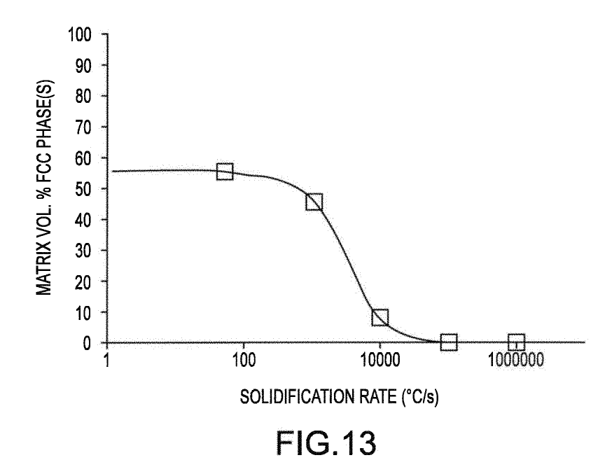

As illustrated in Table 2F, solidification rates on the order of 10,000 to 1,000,000° C./s realized low amounts (e.g., less than 5 vol. %) of the fcc phase in the as-solidified condition. A solidification rate on the order of 10,000° C./s realized a slight increase in the amount of fcc phase in the as-solidified condition at 9 vol. %. However, at a solidification rate of approximately 1,000° C., a large increase in the amount of fcc phase was realized in the as-solidified condition. These results are further illustrated in FIG. 13. Alloy A solidifies by a near-eutectic solidification pathway.

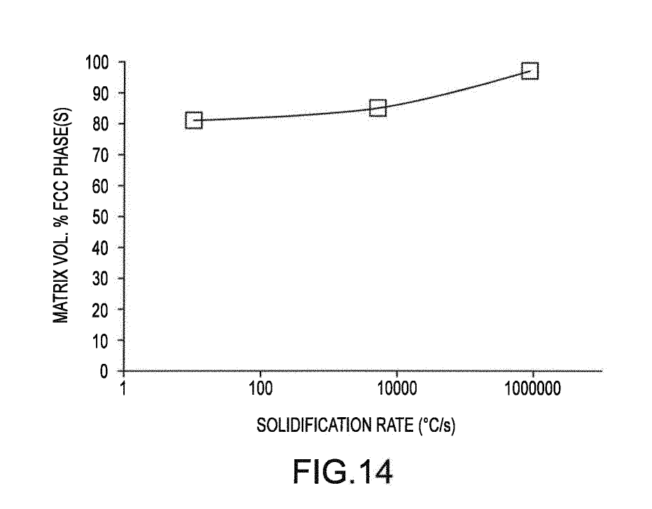

Alloy 6 from Example 1 was also evaluated, the results of which are given in Table 2G and FIG. 14. As illustrated, Alloy 6 realizes a microstructure having fcc as the predominant matrix phase over the solidification range of from 10-1,000,000° C./s. Thus, Alloy 6 realizes an fcc-first solidification pathway.

TABLE 2G
Vol. % of Matrix fcc and bcc versus Solidification
Rate for Example 1 Alloy 6

| | |
|---|---|
| Approximate | |
| Solidification Rate | Matrix Vol. % fcc |

| | | |
|---|---|---|
| 1000000° | C./s | 99 |
| 10,000-100,000° | C./s | 87 |
| 10° | C./s | 83 |

### Hardness Evaluation

Specimens A-14 through A-21 were also subjected to hardness testing in accordance with ASTM E92. Results for the evaluations (given in Vickers Pyramid Numbers (HV)) are given in Table 2H, below. Values are an average of multiple specimens and corresponding uncertainties reflect a normally distributed, 95% confidence interval (i.e., 2-sigma).

TABLE 2H
Hardness Evaluation Results

| Sample No. | Hardness |
|---|---|
| A-14 | 643 ± 42 |
| A-15 | 286 ± 54 |
| A-16 | 616 ± 80 |
| A-17 | 630 ± 40 |
| A-18 | 544 ± 30 |
| A-19 | 389 ± 16 |
| A-20 | — |
| A-21 | 336 ± 21 |

### Tensile Properties Evaluation

Room temperature and elevated temperature tensile properties of samples A-18 through A-21 were tested, the results of which are given in Table 21, below. The sample conditions for the tensile property evaluations correspond to the conditions described in Table 2E. Room temperature tensile properties were evaluated in accordance with ASTM E8 (rev. #8M-16A) and elevated temperature tensile properties were evaluated in accordance with ASTM E21-09.

TABLE 2I
Room Temperature and Elevated Temperature Tensile Properties

| | Room Temp. | | | 450° C. | | | 650° C. | | |
|---|---|---|---|---|---|---|---|---|---|
| Sample | TYS | UTS | Elong. | TYS | UTS | Elong. | TYS | UTS | Elong. |
| No. | (ksi) | (ksi) | (%) | (ksi) | (ksi) | (%) | (ksi) | (ksi) | (%) |
| A-18 | 183 | 240 | 3 | 144 | 205 | 49 | 52 | 101 | 67 |
| A-19 | 142 | 205 | 16 | — | — | — | — | — | — |
| A-20 | 158 | 218 | 7 | 122 | 165 | 11 | 75 | 114 | 18 |
| A-21 | 113 | 186 | 20 | 97 | 144 | 39 | 77 | 105 | 26 |

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A method of additively manufacturing an alloy body having tailored crystallographic regions, the method comprising:
(a) creating an alloy body in an additive manufacturing apparatus, the alloy body having at least a first region and a second region, wherein at least a portion of the alloy body is created by additive manufacturing;
(i) wherein the location of the second region is predetermined relative to the first region;
(ii) wherein the first region comprises a matrix having a crystallographic microstructure;
(iii) wherein the second region comprises a different matrix having a different crystallographic microstructure than the first region;
(iv) wherein the different crystallographic microstructure comprises at least a different composition or a different lattice parameter, or both, relative to the crystallographic microstructure of the first region; and
wherein the creating step (a) comprises:
(A) selectively heating in the additive manufacturing apparatus:
(I) a portion of the first region of the alloy body;
(II) a metal feedstock located proximal the first region of the alloy body; or
(III) both (I) and (II);
thereby producing a melt pool, and
(B) controlling the solidification rate of the melt pool, thereby producing the second region of the alloy body; and
(b) predetermining a crystallographic microstructure of at least one of the first and second regions prior to the creating step (a).

2. The method of claim 1, wherein at least one of the first and second regions comprises a multi-phase microstructure having at least two of: an fcc microstructure, a bcc microstructure, an HCP microstructure, an orthorhombic microstructure and a tetragonal microstructures.

3. The method of claim 2, wherein at least one of the first and second regions comprises a single-phase microstructure consisting essentially of one of: an fcc microstructure, a bcc microstructure, an HCP microstructure, an orthorhombic microstructure and a tetragonal microstructures.

4. The method of claim 1, comprising:
creating the melt pool with an energy source so as to achieve the controlled solidification rate, wherein the pulse associated with the energy source is preselected so as to achieve both the melt pool and the solidification rate associated with the melt pool.

5. The method of claim 1, comprising:
controlling environmental conditions during the additive manufacturing thereby at least partially maintaining the first and second regions.

6. The method of claim 5, wherein the controlling environmental conditions comprises:
controlling a temperature history of the alloy body during the additive manufacturing, thereby at least partially maintaining the first and second regions;
wherein the controlling a temperature history comprises at least one of:
(a) controlling a temperature of at least a portion of a base platen of the additive manufacturing apparatus;
(b) controlling fluid conditions surrounding the alloy body;
(c) controlling gas conditions surrounding the alloy body;
(d) controlled heating of the alloy body followed by controlled quenching of the alloy body via a quench media, thereby at least partially maintaining the first and second regions.

7. The method of claim 5, wherein the controlling environmental conditions comprises:
controlling pressure of the additive manufacturing apparatus during the additive manufacturing.

8. The method of claim 7, comprising:
radiatively heating at least a portion of the alloy body or surrounding feedstock while maintaining a vacuum within the additive manufacturing apparatus.

9. The method of claim 8, wherein the radiatively heating comprises heating the alloy body to within a predetermined percentage of its solidus temperature, but below its solidus temperature.

10. The method of claim 1, wherein the first region is a bulk region, and the second region is at least partially located within the first region.

11. The method of claim 1, comprising producing a plurality of the second regions, wherein the locations of the plurality of second regions are predetermined relative to the first region.

12. The method of claim 1, comprising:
using an energy source to produce the first region, wherein a first pulse is used to create the first region and a second pulse is used to create the second region.

13. The method of claim 12, wherein the same energy source is used to create both the first and second regions.

14. The method of claim 12, wherein a first energy source is used to create the first region, and a different energy source is used to create the second region.

15. The method of claim 1, wherein the composition of the metal feedstock is preselected so as to achieve the second region having the different crystallographic microstructure.

16. The method of claim 1, wherein the first region comprises a first chemistry and the second region comprises a second chemistry different than the first chemistry.

17. The method of claim 1, wherein the first and second regions comprise the same chemistry, but different crystallographic microstructures.

18. The method of claim 1, comprising:
during at least a portion of the creating step (a), maintaining solidification rates at or above a predetermined threshold solidification rate, thereby facilitating production of the first regions; and
during another portion of the creating step (a), maintaining solidification rates below the predetermined threshold solidification rate, thereby facilitating production of the second regions.

19. The method of claim 18, wherein the first regions comprise a single phase microstructure, and wherein the second regions comprise a dual phase microstructure.

20. The method of claim 19, wherein the single phase microstructure consists essentially of bcc and wherein the dual phase microstructure consists essentially of fcc+bcc, and wherein the dual phase microstructure comprises at least 3 vol. % fcc.
